(19) United States
(12) Patent Application Publication
(10) Pub. No.: US 2026/0133514 A1
(43) Pub. Date: May 14, 2026

(54) IMAGE FORMING METHOD

(71) Applicant: Konica Minolta, Inc., Tokyo (JP)

(72) Inventor: Natsuki ITO, Tokyo (JP)

(21) Appl. No.: 19/374,729

(22) Filed: Oct. 30, 2025

(30) Foreign Application Priority Data
Nov. 11, 2024 (JP) 2024-196633

(51) Int. Cl. G03G 9/087

(52) U.S. Cl. CPC G03G 9/08755; G03G 9/08797

(57) ABSTRACT

An image forming method for forming a toner image on a continuous medium using a toner. An area ratio of an element derived from an inorganic fine particle to a total area of all elements measured by X-ray photoelectron spectroscopy (ESCA) of the toner image is within a range of 4 to 10%, the toner has a toner base particle, and the toner base particle contains a release agent and an amorphous polyester.

### CROSS-REFERENCE TO RELATED APPLICATIONS

The entire disclosure of Japanese Patent Application No. 2024-196633 filed on Nov. 11, 2024 is incorporated herein by reference in its entirety.

### BACKGROUND OF THE INVENTION

### Technical Field

The present disclosure relates to an image forming method, and more particularly to an image forming method that ensures separability from the fixing device and excellent post-processing properties without reducing the amount of release agent on the image surface.

### Description of Related Art

In recent years, due to the diversification of printing media and the improvement of the added value of image, electrophotographic printing on printing media other than paper has been required. For example, a continuous medium such as roll sheet or continuous forms is conveyed by a roll-to-roll method, and an image is formed on the conveyed continuous medium by an image forming apparatus. As a toner suitable for continuous media, for example, Japanese Patent Application Laid-Open No. 2016-218448 discloses a toner containing fine particles of polypropylene-based wax.

By the way, labels and stickers output by continuous ledger printing machines on continuous ledger media are frequently post-processed by varnishing or laminating. Therefore, the output image produced by a continuous printing machine is required to have improved post-processing properties such as varnish coatability and adhesion compared to the output image produced by a sheet-fed printing machine.

However, the printing material used for image formation on continuous media contains a release agent such as wax to ensure separation from the fixing device. Therefore, the release agent repelled varnish and adhesive, resulting in insufficient post-processability.

In recent years, high speed and low-temperature fixability have also been required for continuous printing machines, and it has been difficult to achieve both high speed and low-temperature fixability and separation performance in these continuous printing machines.

### SUMMARY OF THE INVENTION

The present disclosure was made in view of the above problems and situations. The problem to be solved by the present disclosure is to provide an image forming method which can ensure separability from the fixing device and excellent post-processing properties, without reducing the amount of release agent on the image surface, even when image formation is performed using a continuous printing machine. Furthermore, the problem to be solved by the present disclosure is to provide an image forming method excellent in high-speed operation and low-temperature fixability in a continuous printing machine.

To achieve the object, the present inventors studied the causes of the above problems. The area ratio of elements derived from inorganic fine particles is set within a specific range with respect to the area of all elements measured by X-ray photoelectron spectroscopy (ESCA) of the toner image, and the toner base particle is made to contain a release agent and an amorphous polyester. As a result, it was found that it excels in separability and post-processing properties from the fixing device, and also in the speed-up of the continuous printing machine and low-temperature fixability.

To achieve at least one of the abovementioned objects, according to an aspect of the present invention, image forming method reflecting one aspect of the present invention is
an image forming method for forming a toner image on a continuous medium using a toner, wherein
an area ratio of an element derived from an inorganic fine particle to a total area of all elements measured by X-ray photoelectron spectroscopy (ESCA) of the toner image is within a range of 4 to 10%,
the toner has a toner base particle, and
the toner base particle contains a release agent and an amorphous polyester.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an overall configuration example of an image forming apparatus according to the present embodiment; and

FIG. 2 is a diagram showing main parts of a control system of an image forming apparatus.

### DETAILED DESCRIPTION

Hereinafter, one or more embodiments of the present invention will be described with reference to the drawings. However, the scope of the invention is not limited to the disclosed embodiments.

An image forming method according to an aspect of the present disclosure is an image forming method that forms a toner image on a continuous medium using toner.

In X-ray photoelectron spectroscopy (ESCA) of the toner image, the area ratio of elements derived from inorganic fine particles to the total area of all elements measured is within the range of 4 to 10%,
the toner has a toner base particle, and

It is characterized in that the toner base particle contains a release agent and an amorphous polyester.

This feature is a technical feature common to or corresponding to each of the following embodiment.

As an embodiment of the present disclosure, it is preferable that the element derived from the inorganic fine particles is Si or Ti, since the hardness of the inorganic fine particles becomes an appropriate condition and a convex portion state suitable for separability from the fixing device can be formed.

It is preferable that the release agent is a hydrocarbon wax. Since hydrocarbon wax does not have polarity, it tends to be arranged at the non-polar sites of the resin on the image surface during fixing. Hydrocarbon wax, compared to ester wax, is distributed in the form of spots on the image surface, thereby improving the post-processing varnish coatability.

The content of the amorphous polyester is within the range of 10 to 50% by mass with respect to the content of the toner base particle, and the toner image is printed on a white toner image containing a white pigment, and it is preferable that the difference in softening point between the white toner containing the white pigment and the toner is 14° C. or less.

When printing a colored toner image on a white toner image containing a white pigment, the amount of white toner may be increased to enhance the hiding power. At that time, since much of the thermal energy during fixing is used for the fixing of the white toner, the action at the interface between the white toner and the colored toner becomes important for ensuring overall fixability. By designing the difference in softening points between the white toner and the colored toner to be small, and by allowing the colored toner to contain a large amount of amorphous polyester, which is advantageous for low-temperature fixing, the compatibility effect between the white toner and the colored toner is enhanced, and the fixability is improved.

Hereinafter, descriptions will be given regarding the present disclosure and its constituent element, and forms and aspects for implementing the present disclosure. In the present description, when two numbers are used to indicate a range of value before and after “to”, these numbers are included in the range as the lower limit value and the upper limit value.

[Overview of the image forming method of the present disclosure] The image forming method of the present disclosure is an image forming method for forming a toner image on a continuous medium using toner, wherein the area ratio of elements derived from inorganic fine particles to the total area of all elements measured by X-ray photoelectron spectroscopy (ESCA) of the toner image is within the range of 4 to 10%, and the toner is characterized by containing a release agent and an amorphous polyester.

It is preferable that the toner is a colored toner containing a colored coloring agent. In addition, the image forming method of the present disclosure prints a colored toner image on top of a white toner image containing a white pigment, and it is preferable that the difference in softening point between the white toner containing a white pigment and the colored toner is 14° C. or less.

In the following description, toners containing colored coloring agents are also referred to as “colored toners” or “toners. A toner containing a white pigment is also referred to as a “white toner.” In the present disclosure, the term “toner” simply refers to colored toner.

### <Area Ratio of Inorganic Particulate-Derived Elements>

The area ratio of elements derived from inorganic fine particles to the total area of all elements measured by X-ray photoelectron spectroscopy (ESCA) of the toner image is within the range of 4 to 10%. It is preferable from the viewpoint of both fixing separation property and post-processing property that the area ratio is within the range of 4.5 to 8%.

In the present disclosure, “element derived from inorganic fine particles” refers to an inorganic element contained in inorganic fine particles. The term “inorganic fine particles” refers to fine particles containing a metal element, and particularly, in the present disclosure, it is preferable that the inorganic fine particles are those added as an external additive.

As the inorganic fine particles, for example, it is preferable that the surface is composed of metal oxide and that the particles are metal oxide particles. Examples of metal oxides that make up inorganic fine particles include, without limitation, aluminum oxide (alumina), silicon oxide (silica), magnesium oxide, zinc oxide, lead oxide, tin oxide, tantalum oxide, indium oxide, bismuth oxide, yttrium oxide, cobalt oxide, copper oxide, manganese oxide, Selenium oxide, iron oxide, zirconium oxide, germanium oxide, tin oxide, titanium oxide (titania), niobium oxide, molybdenum oxide, vanadium oxide, copper aluminum oxide, tin oxide doped with antimony ions, etc. These inorganic particles can be used alone or in combination.

Among these inorganic particles, aluminum oxide particles, tin oxide particles, titanium oxide particles, or silicon oxide particles (silica particles) are preferred, and titanium oxide or silicon oxide particles are more preferred.

In the present disclosure, it is preferable that the element derived from inorganic fine particles is silicon, titanium, or aluminum, and more preferably silicon or titanium.

In the present disclosure, “all elements measured by ESCA of the toner image” refers to all elements contained in the material of the toner. In the present disclosure, “all elements measured by ESCA of the toner image” are preferably, for example, carbon elements, oxygen elements, and elements derived from the inorganic fine particles.

X-ray photoelectron spectroscopy is performed using an X-ray photoelectron spectrometer, for example, K-Alpha (Thermo Fisher Scientific), under the following measurement conditions.

The peak area of the carbon element (peak area C) present within 3 nm from the outermost surface of the toner particles, the peak area of the oxygen element (peak area O), and the peak area of the element derived from inorganic fine particles are specified.

The peak areas of the aforementioned inorganic particulate-derived elements include, for example, the peak area of the silicon element and the peak area of the titanium element.

Each peak area is identified from its respective atomic peak area using a relative sensitivity factor. Then, from each peak area obtained, the area ratio of inorganic particulate-derived elements to the area of all elements is calculated based on the following formula A.

(Total peak area of inorganic particulate-derived elements)/(Peak area C+Peak area O+Total peak area of inorganic particulate-derived elements)×100 formula A:

### (Measurement Condition)

X-ray: Al monochrome source
Acceleration: 12 kV, 6 mA
Resolution: 50 eV
Beam-based: 400 μm
Path Energy: 50 eV
Step Size: 0.1 eV

Even when a colored toner image by colored toner is formed on a white toner image by a white toner, since the white toner image is formed under the colored toner image, the elements measured by X-ray photoelectron spectroscopy are the elements contained in the colored toner image, not the elements contained in the white toner image. Therefore, even when a white toner image is formed under a colored toner image, the area ratio of the element derived from the inorganic fine particles is the area ratio of the element derived from the inorganic fine particles in the colored toner image, which becomes the “area ratio of the element derived from the inorganic fine particles” in the present disclosure, without being affected by the white toner image.

As means for setting the area ratio of the element derived from inorganic fine particles within a range of 4 to 10%, for example, adjustment of the amount of external additive added, the average particle diameter of the external additive, or the hardness of the surface of the toner base particles can be mentioned.

Specifically, it is preferable that the addition amount of external additive is within the range of 0.05 to 5 parts by mass with respect to 100 parts by mass of toner base particle. When titanium oxide particles are used as an external additive, the number average primary particle diameter of the titanium oxide particles is preferably in the range of 60 to 120 nm. In addition, when silica particles are used as an external additive, the number average primary particle diameter of the silica particles is preferably in the range of 10 to 120 nm. The method for measuring the aforementioned number-average primary particle diameter is described below.

The hardness of the toner base particle surface can be controlled by adjusting the content of the chain transfer agent. When the content of the chain transfer agent is increased, the surface of the toner base particle becomes softer, and the inorganic fine particles, which are external additives, are more likely to be buried in the surface of the formed image. Therefore, the aforementioned area ratio of inorganic particulate-derived elements becomes smaller. On the other hand, when the content of the chain transfer agent is reduced, the surface of the toner base particle becomes hard, and the inorganic fine particles, which are external additive, are less likely to be buried in the surface of the formed image. The amount of external additive protruding from the image surface increases, and the area ratio of the element derived from inorganic fine particles becomes larger. The amount of chain transfer agent added varies depending on the desired molecular weight and molecular weight distribution, but specifically, it is preferably within a range of, for example, 0.1 to 5.0% by mass with respect to the polymerizable monomer.

### <Image Formation>

For the formation of toner image measured by X-ray photoelectron spectroscopy, “AccurioLabel 400” (manufactured by Konica Minolta) is used as an image forming apparatus (continuous printing machine) for continuous feed media. A two-component developer is loaded in this apparatus as a developer. Under an environment of normal temperature and normal humidity (temperature 22° C., humidity 50% RH), image formation is performed using N Mirror 73/P22/L8W (manufactured by Oji Tack Co., Ltd.) as the printing medium. The amount of adhesion in the image before fixing is adjusted so that the amount of adhesion becomes the amount of adhesion in Table IV in the example described later. Thereafter, the surface temperature of the fixing heating member is set to 200° C., and an image is output. The above image forming apparatus for continuous sheet media is capable of high-speed printing, and can print at, for example, 20 to 40 m/min.

### <Continuous Medium>

As the continuous medium used in the present disclosure, continuous forms and roll sheet, etc. are exemplified. The continuous medium can be applied to roll-to-roll printing and processing technology to improve production efficiency.

It is preferable that the thickness of the continuous medium is 75 μm or less, as this covers general recording medium and enables an image in which fixing failure does not occur to be obtained. The thickness of the continuous media is more preferably in the range of 50 to 75 μm.

The continuous medium preferably has transparency and flexibility, and is, for example, a medium made of a resin such as polyethylene terephthalate (PET), polypropylene (PP), polyethylene (PE), or polyolefin (PO).

The continuous media may be a single layer or a multi-layer consisting of two or more layers of continuous media joined together via an adhesive layer. The surface of the continuous medium may be untreated by corona treatment, plasma treatment, or the like, but it is preferable to perform corona treatment, plasma treatment, or the like from the viewpoint of adhesiveness.

In particular, in the present disclosure, it is preferable in terms of fixability and adhesiveness that the continuous medium is a polyethylene terephthalate film having a thickness of 50 μm.

### <Softening Point>

The image forming method of the present disclosure preferably has a difference in softening point between the white toner and the colored toner of 14° C. or less. The difference in the softening point is more preferably within the range of 0 to 12° C.

The difference in softening point (° C.) can be calculated as the absolute value of the difference between the softening point (° C.) of the colored toner and the softening point (° C.) of the white toner (softening point (° C.) of the colored toner-softening point (° C.) of the white toner). The softening points of colored toner and white toner can be measured, for example, by the following method. Using a flow tester “CFT-500D” (manufactured by Shimadzu Corporation), 1 g of sample is heated at a rate of 6° C./min, and a load of 1.96 MPa is applied by a plunger to extrude the sample from a nozzle with a diameter of 1 mm and a length of 1 mm. The plunger drop of the flow tester is plotted against temperature, and the temperature at which half of the sample has flowed out is the softening point.

The softening point of colored toner is preferably in the range of 80 to 120° C. The softening point of white toner is preferably in the range of 80 to 110° C.

[Toner] Hereinafter, the configuration of toner (colored toner) will be described.

In this specification, “toner” refers to electrostatic latent image developing toner. The toner includes toner particles comprising toner base particles and external additives disposed on the surface of the toner base particles.

The “toner base particle” is the base particle of the “toner particle”. The toner base particle to which an external additive is added is referred to as “toner particle”. The term “toner” refers to an aggregate of toner particles.

The term “toner image” refers to a state in which toner is aggregated in the form of an image.

The toner according to the present disclosure contains toner base particle and external additive. The toner base particle contains a release agent and an amorphous polyester. In addition, the toner base particle may contain, as required, components such as binder resin, coloring agent, and charge control agent other than amorphous polyester.

### [Toner Base Particle]

### Binder Resin

The toner base particle according to the present disclosure contains an amorphous polyester. Further, the toner base particle may contain a binder resin other than an amorphous polyester. By containing binder resin, the toner base particle can fix the toner on the continuous medium.

Examples of binder resins other than amorphous polyester include vinyl resin, urethane resin, urea resin, and crystalline resin. In the present disclosure, it is preferable to contain a binder resin, a vinyl resin and an amorphous polyester resin.

In the present disclosure, “shows amorphousness” means that, in the endothermic curve obtained by differential scanning calorimetry (DSC: Differential Scanning Calorimetry), it has a glass transition temperature (Tg) but does not have a melting point, that is, a clear endothermic peak upon heating. The clear endothermic peak refers to an endothermic peak having a half width of 15° C. or less in an endothermic curve when the temperature is increased at a temperature increase rate of 10° C./min.

### <<Amorphous Polyester>>

From the viewpoint of low-temperature fixability, the toner base particle according to the present disclosure contains an amorphous polyester.

The term “amorphous polyester” refers to a polyester obtained by a polycondensation reaction between a polyvalent carboxylic acid monomer and a polyvalent alcohol monomer, which exhibits amorphous properties. The amorphous polyester can be synthesized by polycondensation (esterification) of the aforementioned polyvalent carboxylic acid monomer and polyhydric alcohol monomer using a known esterification catalyst.

A polyvalent carboxylic acid is a compound containing two or more carboxy groups in one molecule.

Examples of the polyvalent carboxylic acid include phthalic acid, isophthalic acid, terephthalic acid, trimellitic acid, naphthalene-2,6-dicarboxylic acid, malonic acid, mesaconic acid, dimethyl isophthalate, fumaric acid, dodecenyl succinic acid, and 1,10-dodecanedicarboxylic acid. Among these, dimethyl isophthalate, terephthalic acid, dodecenyl succinic acid, and trimellitic acid are preferable.

These may be contained alone or in combination of two or more.

A polyhydric alcohol is a compound containing two or more hydroxy groups in one molecule.

As the polyhydric alcohol, for example, ethylene glycol, propylene glycol, butanediol, diethylene glycol, pentanediol, neopentyl glycol, hexanediol, heptanediol, cyclohexanediol, octanediol, decanediol, dodecanediol and other divalent alcohols; glycerin, pentaerythritol, hexamethylol melamine, hexaethylol melamine, tetramethylol benzoguanamine, tetraethylol benzoguanamine and other polyols having three or more valences; and ester compounds thereof; hydroxycarboxylic acid derivatives and the like can be mentioned.

These may be contained alone or in combination of two or more.

In addition, bisphenols, like alcohols, can be esterified, and from this perspective, in the present disclosure, the above “polyhydric alcohol” is intended to include bisphenol A or a bisphenol A derivative. Examples of bisphenol A derivatives include an ethylene oxide adduct of bisphenol A (BPA-EO) and a propylene oxide adduct of bisphenol A (BPA-PO).

Among these, the polyhydric alcohol is preferably an aliphatic polyhydric alcohol or an alicyclic polyhydric alcohol. In particular, the polyhydric alcohol is preferably an acyclic aliphatic polyhydric alcohol having 5 or more carbon atoms, and most preferably an aliphatic polyhydric alcohol having 5 to 7 carbon atoms.

Since the aliphatic polyhydric alcohol having 5 to 7 carbon atoms has a relatively small volume (bulkiness), it is easy to make the inter-bond distance of the ester bond uniform in the polyester obtained by synthesis. Furthermore, a portion where the density of ester groups is locally high is less likely to be formed. Specifically, it is assumed that a hydrophilic moiety derived from an ester bond and a hydrophobic moiety derived from a hydrocarbon group are appropriately dispersed, and thus, charge leakage can be suppressed.

In particular, an aliphatic polyhydric alcohol having 5 to 7 carbon atoms is less bulky than bisphenol A or a bisphenol A derivative. Therefore, it is considered that the aliphatic polyhydric alcohol having 5 to 7 carbon atoms can reduce charge leakage as compared with bisphenol A or a bisphenol A derivative.

Examples of the aliphatic polyhydric alcohol having 5 to 7 carbons include pentanediol, neopentyl glycol, hexanediol, heptanediol and cyclohexane diol.

From the viewpoint of suppressing charge leakage, the proportion of bisphenol A or a bisphenol A derivative in the polyhydric alcohol is preferably low.

In the present disclosure, the content ratio of structural units derived from bisphenol A or bisphenol A derivatives to the total number of moles of structural units derived from polyhydric alcohol is 10 mol % or less. It is considered that this can suppress charge leakage and unevenness of density of an image to be formed.

The content of the structural units derived from bisphenol A or a bisphenol A derivative with respect to the total moles of the structural units derived from the polyhydric alcohol is preferably lower. Specifically, the content is preferably 5 mol % or less, and more preferably 1 mol % or less.

The structural units derived from a polyhydric alcohol may not contain a structural unit derived from bisphenol A or a bisphenol A derivative at all.

Examples of the esterification catalyst include alkali metal compounds such as sodium and lithium; alkaline earth metal compounds such as magnesium and calcium; metal compounds such as aluminum, zinc, manganese, antimony, titanium, tin, zirconium, and germanium; phosphorous acid compounds; phosphoric acid compounds; and amine compounds.

The polymerization temperature is not particularly limited and is, for example, preferably within the range of 150 to 250° C. The polymerization time is not particularly limited and is, for example, preferably in a range of 0.5 to 10 hours. During the polymerization, the pressure in the reaction system may be reduced as necessary.

The content of the amorphous polyester is preferably in the range of 5 to 80% by mass and more preferably in the range of 10 to 50% by mass with respect to the total mass of the binder resin.

In addition, the content of the amorphous polyester is preferably 10% by mass or more and more preferably 40% by mass or more with respect to the total mass of the toner base particle.

### <<Hybrid Amorphous Polyester>>

The amorphous polyester may be a hybrid crystalline polyester in which amorphous polyester polymerized segments and amorphous polymerized segments other than the amorphous polyester are chemically bonded with each other.

### <<Vinyl Resin>>

The vinyl resin is a resin obtained by polymerization using at least a vinyl-based monomer.

Examples of the amorphous vinyl resin include an acrylic resin and a styrene-acrylic resin. Among these, as the amorphous vinyl resin, a styrene-acrylic resin formed using a styrene-based monomer and a (meth) acrylic acid ester-based monomer are preferable.

Specific examples of the styrene-based monomer and the (meth)acrylic acid ester-based monomer capable of forming the styrene-acrylic resin are shown below. However, those that can be used for the formation of styrene-acrylic resin used in the present disclosure are not limited to those shown below.

Examples of the styrene-based monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof.

These styrene-based monomers can be used alone or in combination of two or more.

### ((Meth)Acrylic Acid Ester Monomer)

Examples of the (meth)acrylate ester-based monomer include: acrylic acid ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic acid esters such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

The content of the styrene-acrylic resin is preferably 70% by mass or more with respect to the total amount of the binder resin. Within this range, an effect of improving chargeability can be sufficiently exhibited.

As the polymerizable monomer, a third polymerizable monomer can also be used in addition to the above-described polymerizable monomers. Examples of the third polymerizable monomer include an acid monomer such as acrylic acid, methacrylic acid, maleic anhydride, and vinylacetic acid. Examples of the third polymerizable monomer also include acrylamide, methacrylamide, acrylonitrile, ethylene, propylene, butylene vinyl chloride, N-vinylpyrrolidone, and butadiene.

Further, as the third polymerizable monomer, a polyfunctional vinyl monomer may be used. Examples of the polyfunctional vinyl monomer include diacrylates such as ethylene glycol, propylene glycol, butylene glycol, and hexylene glycol, and dimethacrylates and trimethacrylates of tertiary or higher alcohols such as divinylbenzene, pentaerythritol, and trimethylolpropane.

The manufacturing method of styrene-acrylic resin is not particularly limited, and examples include a method of performing polymerization by known polymerization techniques such as bulk polymerization, solution polymerization, emulsion polymerization, mini-emulsion method, and dispersion polymerization. In addition, any polymerization initiator such as peroxides, persulfides, persulfates, azo compounds, etc., which are normally used in the polymerization of the above monomers, can be used in the above production method.

In addition, a chain transfer agent commonly used for the purpose of adjusting molecular weight can be used. Chain transfer agents are not limited to alkyl mercaptans such as n-octyl mercaptan, mercapto fatty acid esters, etc.

In addition, as described above, the content of the chain transfer agent is preferably within a range of, for example, 0.1 to 5.0% by mass with respect to the polymerizable monomer. By adjusting the amount of chain transfer agent, the hardness of the resin can be controlled, and the hardness of the toner base particle surface can be controlled. This allows the aforementioned area ratio of inorganic particulate-derived elements to be controlled within the range of 4-10%.

### <<Glass Transition Temperature>>

From the viewpoint of achieving both sufficient low-temperature fixability and heat-resistant storage property, the glass transition temperature (Tg) of the amorphous resin is preferably in the range of 30 to 70° C. and more preferably in the range of 40 to 65° C.

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). To be specific, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. During the first and second temperature increase, the temperature is raised from 0° C. to 150° C. at a rate of 10° C./min, and 150° C. is maintained for 1 minute. In the temperature decrease, the temperature is decreased from 150° C. to 0° C. at a temperature lowering rate of 10° C./min, and the temperature is held at 0° C. for 1 minute. In the measurement curve obtained during the second heating, a shift of the base line is observed. The intersection of an extended line of the base before the shift and a tangent line indicating the maximum inclination of the shifted portion of the base is defined as the glass transition temperature (Tg). An empty aluminum pan is used for a reference.

### Crystalline Resin

The toner base particle according to the present disclosure may contain crystalline resin. By containing crystalline resin, when the crystalline resin exceeds its melting point, the crystalline portion melts, and the crystalline resin and the amorphous polyester become compatible, thereby improving low-temperature fixability.

In the present disclosure, “crystallinity” refers to having a distinct endothermic peak, rather than a stepwise endothermic change, at the melting point during heating in the endothermic curve obtained by DSC (differential scanning calorimetry). The clear endothermic peak refers to a peak having a half value width of 15° C. or less in an endothermic curve when the temperature is increased at a temperature increase rate of 10° C./min.

As the crystalline resin, known crystalline resin, for example, crystalline polyester and crystalline polyurethane are preferably used. In particular, crystalline polyester is preferable from the viewpoints of sharp melting property during melting and compatibility with the binder resin. That is, the moiety having a crystal structure preferably contains a crystalline polyester.

The content of the crystalline polyester is preferably within a range of 0.1 to 15% by mass with respect to the total mass of the binder resin.

### <<Crystalline Polyester>>

The term “crystalline polyester” refers to a known polyester obtained by a polycondensation reaction between a polyvalent carboxylic acid (polyvalent carboxylic acid) and a polyvalent alcohol (polyvalent alcohol), which exhibits crystallinity.

The crystalline polyester preferably has a structural unit derived from an aliphatic diol and a structural unit derived from an aliphatic carboxylic acid. In addition, the crystalline polyester preferably has only a structural unit derived from an aliphatic diol and a structural unit derived from an aliphatic carboxylic acid.

The number of carbon atoms of the aliphatic diol or the aliphatic carboxylic acid is more preferably in a range of 6 to 10. When the crystalline polyester has a structure which is not relatively bulky, it is considered that the ester group can be prevented from being locally present at a high density, which prevents leakage of charges.

A polyvalent carboxylic acid is a compound containing two or more carboxy groups in one molecule.

Examples of the polyvalent carboxylic acid include saturated aliphatic dicarboxylic acids such as oxalic acid, malonic acid, succinic acid, adipic acid, sebacic acid, azelaic acid, n-dodecylsuccinic acid, nonanedioic acid, decanedioic acid, undecanedioic acid, dodecanedioic acid (dodecanedioic acid), tetradecanedioic acid (tetradecanedioic acid); alicyclic dicarboxylic acids such as cyclohexane dicarboxylic acid; aromatic dicarboxylic acids such as phthalic acid, isophthalic acid, terephthalic acid; polyvalent carboxylic acids having three or more valencies such as trimellitic acid, pyromellitic acid; and anhydrides of these carboxylic acid compounds. In addition, other examples include alkyl esters having 1 to 3 carbon atoms. The crystalline polyester may contain only one of them, or may contain two or more of them.

A polyhydric alcohol is a compound containing two or more hydroxy groups in one molecule.

Examples of polyhydric alcohols include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, dodecanediol, neopentyl glycol, 1,4-butenediol; and polyhydric alcohols having three or more hydroxyl groups such as glycerin, pentaerythritol, trimethylolpropane, and sorbitol. The crystalline polyester may contain only one of them, or may contain two or more of them.

A method for synthesizing the crystalline polyester is not particularly limited. The polyester resin can be synthesized by polycondensation (esterification) of the above-described polyhydric alcohol component and polycarboxylic acid component using a known esterification catalyst.

The ratio between the polyhydric alcohol component and the polycarboxylic acid component is not particularly limited. For example, the equivalent ratio of hydroxy group in the polyvalent alcohol component to carboxy group in the polyvalent carboxylic acid component is preferably within a range of 1.5/1 to 1/1.5, and more preferably within a range of 1.2/1 to 1/1.2.

Examples of the catalyst that can be used in the synthesis of the crystalline polyester include compounds of alkali metals such as sodium and lithium; compounds of alkaline earth metals such as magnesium and calcium; compounds of metals such as aluminum, zinc, manganese, antimony, titanium, tin, zirconium, and germanium; phosphite compounds; phosphate compounds; and amine compounds.

Specifically, examples of the tin compound include dibutyltin oxide, tin octylate, tin dioctylate, and the salts thereof.

Examples of the titanium compound include titanium alkoxides such as tetra-n-butyl titanate, tetraisopropyl titanate, tetramethyl titanate, and tetrastearyl titanate; titanium acylates such as polyhydroxy titanium stearate; and titanium chelates such as titanium tetraacetylacetonate, titanium lactate, and titanium triethanolaminate.

Examples of the germanium compound include germanium dioxide.

Examples of the aluminum compound include oxides such as polyaluminum hydroxide, aluminum alkoxide, and tributyl aluminate.

They may be used alone or in combination of two or more.

The polymerization temperature and the polymerization time are not particularly limited, and the pressure in the reaction system may be reduced as necessary during the polymerization.

From the viewpoint of low-temperature fixability and hot offset resistance, the melting point (Tm) of the crystalline resin is preferably in a range of 55 to 90° C., and more preferably in a range of 60 to 85° C. The melting point of the crystalline resin can be controlled by controlling its resin composition.

When the crystalline resin is a crystalline polyester, the melting point of the crystalline polyester is preferably 75° C. or lower.

The melting point (Tm) is a peak top temperature in the endothermic peak, and can be measured by DSC (differential scanning calorimetry).

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). Specifically, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. During the first and second temperature increase, the temperature is raised from 0° C. to 150° C. at a rate of 10° C./min, and 150° C. is maintained for 1 minute. In the temperature decrease, the temperature is decreased from 150° C. to 0° C. at a temperature lowering rate of 10° C./min, and the temperature is held at 0° C. for 1 minute. The temperature at the top of the endothermic peak in the endothermic curve obtained during the second heating is measured as the melting point.

### <<Weight-Average Molecular Weight>>

The weight-average molecular weight of the crystalline resin is not particularly limited. From the viewpoint of tacking suppression and low-temperature fixability, the weight average molecular weight is preferably in a range of 1,000 to 29,000, more preferably in a range of 1,000 to 20,000, and further preferably in a range of 1,000 to 15,000.

The weight-average molecular weight of the crystalline resin can be measured by the following method.

For example, an apparatus of gel permeation chromatography “HLC 8320GPC” (manufactured by Tosoh Corp.), in which one column “TSK gel guard column SuperHZ-L”, and three columns “TSK gel Super HZM-M” (all manufactured by Tosoh Corp.) are connected, is used.

The columns (TSK-) are stabilized at 40° C., and tetrahydrofuran (THF) as a carrier-solvent is allowed to flow through the columns at the same temperature at a flow rate of 0.35 m/min. THF solution of the measurement sample (resin) adjusted to have a sample concentration of 1 mg/mL is treated with a roll mill at room temperature for 10 minutes. The solution is treated with a membrane filter having a pore size of 0.2 μm to obtain a sample solution. The sample solution (10 μL) is injected into the apparatus together with the carrier solvent, and the measurement is performed using a carrier detector (RI detector).

A calibration curve is drawn using polystyrene standard samples having a monodisperse molecular weight distribution. The molecular weight distribution of the measurement sample is calculated based on the calibration curve. The calibration curves were prepared using TOSOH Corporation's “Polystyrene Standard Sample TSK Standard”: 10 samples of “A-500”, “F-1”, “F-10”, “F-80”, “F-380”, “A-2500”, “F-4”, “F-40”, “F-128”, and “F-700”.

The data collection interval in the sample analysis is 300 ms.

Further, after separation of the crystalline resin and release agent in the toner, the weight-average molecular weight of the crystalline resin may be calculated by the above measurement method.

### <Release Agent>

The release agent is not particularly limited, and examples thereof include various known release agents. The release agent is preferably a wax.

Examples of release agent that are waxes include hydrocarbon waxes such as polyethylene wax, paraffin wax, microcrystalline wax, and Fischer-Tropsch wax; dialkyl ketone wax such as those containing distearyl ketone; carnauba wax; montan wax; behenyl behenate; trimethylolpropane tribeheneate; pentaerythritol tetramyristate; pentaerythritol tetrastearate; pentaerythritol tetrabehenate; pentaerythritol diacetate dibehenate; glycerin tribehenate; 1,18-octadecanediol distearate; trimellitic acid tristearyl; and ester wax such as those containing distearyl maleate; sebacic acid stearyl; ethylene glycol palmitate; ethylene glycol stearate; diester wax; and amide wax such as those containing ethylenediamine dibehenylamide and trimellitic acid tristearylamide.

Of these, hydrocarbon waxes are preferred. As the hydrocarbon wax, for example, Fischer-Tropsch wax or microcrystalline wax is preferable.

The hydrocarbon wax preferably has a melting point of 50 to 95° C. When the melting point of the hydrocarbon wax is equal to or higher than 50° C., the hydrocarbon wax exuding from the toner particles is easily crystallized. Accordingly, the toner releasing effect and the abrasion resistance of formed image are enhanced.

When the melting point of the hydrocarbon wax is equal to or lower than 95° C., the hydrocarbon wax is more likely to exude from the toner base particle in fixing. Accordingly, the toner releasing effect and the abrasion resistance of formed image are enhanced. Further, when the melting point of the hydrocarbon wax is equal to or lower than 95° C., the toner base particle is likely to melt during fixing, and the toner can be fixed at a low temperature. From the above viewpoints, it is preferable that the melting point of the hydrocarbon wax (in particular, the hydrocarbon wax having 36 to 76 carbon atoms) be 80 to 90° C.

The amount of the contained release agent is preferably 3 to 20% by mass with respect to the total mass of the toner base particle and more preferably 5 to 15% by mass. When the amount of the contained release agent is equal to or greater than 3% by mass, the toner releasability from a fixing member is sufficiently enhanced. When the amount of the contained release agent is equal to or less than 20% by mass, the toner base particle can contain a sufficient amount of binder resin, and the image fixability is sufficiently enhanced.

### <Coloring Agent>

As the coloring agent, a colored coloring agent is used, and there are no particular limitations. Various known dyes and pigments can be used.

As the coloring agent for black toner (Bk), a known coloring agent as a black coloring agent can be used. As the black coloring agent, specifically, carbon black, magnetic material, iron-titanium composite oxide black, and the like can be used. Carbon black includes channel black, furnace black, acetylene black, thermal black, lamp black, etc. Magnetic materials include ferrite and magnetite.

As the coloring agent for yellow toner (By), a known coloring agent as a yellow coloring agent can be used. Specifically, as a yellow coloring agent, C.I. Solvent Yellow 19, 44, 77, 79, 81, 82, 93, 98, 103, 104, 112, 162, etc. can be used as dyes. In addition, as the pigment, C.I. Pigment Yellow 14, 17, 74, 93, 94, 138, 155, 180, 185, and the like can be used, and mixtures thereof can also be used.

As the coloring agent for magenta toner (Bm), a coloring agent known as a magenta coloring agent can be used. Specifically, as the magenta coloring agent, C.I. Solvent Red 1, 49, 52, 58, 63, 111, 122, etc. can be used as dyes. As the pigment, C.I. Pigment Red 5, 48:1, 53:1, 57:1, 122, 139, 144, 149, 166, 177, 178, 222, etc. can be used, and mixtures thereof can also be used.

As the coloring agent for cyan toner (Bc), a known coloring agent as a cyan coloring agent can be used. Specifically, as a cyan coloring agent, C.I. Solvent Blue 25, 36, 60, 70, 93, 95, etc. can be used as dyes. As the pigment, C.I. Pigment Blue 1, 7, 15, 60, 62, 66, 76, 15:3, etc. can be used, and mixtures thereof can also be used.

The content ratio of the colored coloring agent in the toner base particle is preferably in the range of 0.5 to 20 parts by mass with respect to 100 parts by mass of binder resin, and more preferably in the range of 2 to 10 parts by mass.

### <Charge Control Agent>

Examples of the charge control agent include various known compounds.

The content of the charge control agent is preferably in the range of 0.1 to 5.0% by mass with respect to the total mass of the binder resin.

[external additive] The toner according to the present disclosure has an external additive further added to the toner base particle. Addition of an external additive can further improve the fluidity, chargeability, and cleanability of the toner. In addition, by adding an external additive, the area ratio of the element derived from the above-mentioned inorganic fine particles can be set within the range of 4 to 10%.

As the external additive, the above-mentioned inorganic fine particles can be used. In particular, it is preferable that the external additive is silica particles or titanium oxide particles. The inclusion of titanium dioxide particles is preferred in that charge leakage is suppressed by uniformly attached titanium dioxide particles.

The number-average primary particle size of titanium dioxide particles should be in the range of 60 to 120 nm. The number-average primary particle size of the titanium dioxide particles should be larger than the number-average primary particle size of the silica particles. The number-average primary particle size of silica particles should be in the range of 10 to 120 nm.

The aforementioned measurement of the number-average primary particle size is performed, for example, by the following method. Using a scanning electron microscope (SEM), for example, “JEM-7401F” (manufactured by JEOL Ltd.), an SEM image of the inorganic fine particles enlarged to an appropriate magnification is photographed. After binarizing the photographed image using an image processing and analysis device, for example, “LUZEX AP (manufactured by NIRECO Corporation)”, the horizontal direction Feret diameter of 100 inorganic fine particles is calculated, and the average value is defined as the number average primary particle diameter.

The magnification of the SEM image is set so that the total number of inorganic fine particles in the observation area is about 100 to 200. This measurement method is also applicable to the number-average primary particle size of organic particles.

Silica particles and titanium oxide particles may be surface-modified by gloss treatment, hydrophobic treatment, etc. with silane coupling agents, titanium coupling agents, higher fatty acid, silicone oil, etc. for improvement of heat-resistant storage property and environmental stability.

Dimethyldimethoxysilane, hexamethyldisilazane (HMDS), methyltrimethoxysilane, isobutyltrimethoxysilane, and decyltrimethoxysilane are preferred silane coupling agents.

From each of the above perspectives, silica particles should be surface-modified with silicone fluid.

As the silica particles used for surface modification, any silica particles produced by any known method can be used without limitation.

Methods for making silica particles include hydrolyzing alkoxysilane (sol-gel method) and vaporizing silicon chloride and synthesizing silica particles by a gas-phase reaction in a high-temperature hydrogen flame (gas phase method, gas combustion method). The method of making silica particles includes a method in which a mixed raw material consisting of finely milled silica silica, a reducing agent such as metallic silicon powder or carbon powder, and water to make a slurry is heat treated at high temperature under a reducing atmosphere to generate SiO gas, and said SiO gas is cooled in an atmosphere containing oxygen (melting method), etc.

A narrow particle diameter distribution is easily obtained, and in terms of suppressing variation in the adhesion strength of the external additive to the white toner base particles, it is preferable that the silica particles are silica particles produced by the sol-gel method.

Known silicone fluids can be used to surface-modify silica particles. As the silicone oil, dimethyl silicone oil, alkyl-modified silicone oil, amino-modified silicone oil, carboxyl-modified silicone oil, epoxy-modified silicone oil, fluorine-modified silicone oil, alcohol-modified silicone oil, polyether-modified silicone oil, methylphenyl silicone oil, methylhydrogen silicone oil, mercapto-modified silicone oil, higher fatty acid-modified silicone oil, phenol-modified silicone oil, methacrylic acid-modified silicone oil, polyether-modified silicone oil, methylstyryl-modified silicone oil and the like can be used.

The silicone oil used for surface modification may be used alone or in combination of two or more kinds, as long as it does not inhibit the effect manifestation of the invention. Among these, dimethyl silicone fluid is preferred as the silicone fluid from the viewpoint of cost and ease of handling. Also, it is preferable that the kinematic viscosity of dimethyl silicone oil is 10 to 100 mm2/s at 25° C.

The silica particles may be hydrophobically treated with a silane coupling agent or the like before surface modification with silicone fluid.

Furthermore, as an external additive, in addition to the silica particles and titanium oxide particles, other known inorganic fine particles, organic fine particles, and lubricants may also be added.

Other known inorganic particles mentioned above include inorganic particles made of alumina, strontium titanate, zinc titanate, calcium titanate, etc. Two types or more of these may be combined. The number-average primary particle size of these other inorganic particles should be 10 to 100 nm. The measurement of the number-average primary particle diameter of other inorganic particles is the same as the method for measuring the number-average primary particle diameter of silica particles and titanium oxide particles.

These inorganic particles may also be made hydrophobic by surface modification if necessary.

Silane coupling agents and titanium coupling agents are examples of surface modifiers used to surface modify inorganic particles. Dimethyldimethoxysilane, hexamethyldisilazane (HMDS), methyltrimethoxysilane, isobutyltrimethoxysilane, and decyltrimethoxysilane are preferred silane coupling agents.

Further, a higher fatty acid and silicone oil can also be used as a surface modifier. The same silicone fluids as described above can be used as silicone fluids.

Spherical organic particles with a number-average primary particle size of 10 to 200 nm can be used as organic fine particles. Specifically, organic fine particles made from monopolymer such as styrene and methyl methacrylate or their copolymers can be used.

The lubricant is used for the purpose of further improving cleanability and transferability.

As examples of lubricants, metal salts of higher fatty acid such as zinc, aluminum, copper, magnesium, calcium, etc. salts of stearic acid; zinc, manganese, iron, copper, magnesium, etc. salts of oleic acid; zinc, copper, magnesium, calcium, etc. salts of palmitic acid; zinc, calcium, etc. salts of linoleic acid; zinc, calcium, etc. salts of ricinoleic acid can be mentioned. These external additive may be used in combination of various kinds thereof.

The amount of inorganic fine particles added as an external additive is preferably in the range of 0.05 to 5 parts by mass with respect to 100 parts by mass of toner base particle, and more preferably in the range of 0.1 to 4.5% by mass.

In addition, the total amount of external additives containing inorganic fine particles and organic fine particles other than inorganic fine particles is preferably in the range of 0.05 to 5% by mass based on the total mass of the toner base particle, and more preferably in the range of 0.1 to 3% by mass.

### [Physical Property of Toner]

### <Toner Particle Diameter>

The average particle size of the toner particles is, for example, preferably within a range of 3 to 10 μm, and more preferably within a range of 4 to 8 μm, in terms of a volume-based median diameter (D50).

The average particle diameter of the toner particles can be controlled by controlling the concentration of a coagulant used in the production, the amount of an organic solvent added, a fusion time, the composition of the binder resin, and the like.

When the volume-based median size (D50) is within the above range, a very fine dot image at the 1200 dpi level can be faithfully reproduced.

The volume-based median size (D50) of the toner particles is measured and calculated by using a measurement apparatus in which “Multisizer 3” (manufactured by Beckman Coulter, Inc.) is connected to a computer system equipped with the software for data processing “Software V3.51.

Specifically, first, a toner sample to be measured is added to a surfactant solution to be mixed, diluted with pure water, and then subjected to ultrasound dispersion to prepare toner particle dispersion. As the surfactant solution, for example, an anionic surfactant such as sodium polyoxyethylene lauryl ether sulfate is suitably used for the purpose of dispersing the toner particles.

The toner particle dispersion is injected into a beaker containing “ISOTONII” (manufactured by Beckman Coulter, Inc.) placed in a sample stand with a pipette until the concentration displayed in the measurement apparatus reaches 6 to 8%. With this concentration, a measurement value can be obtained with high reproducibility.

Next, the number of particles counted and the aperture diameter of the measurement apparatus are set to 25000 and 100 μm, respectively. The range of 2 to 60 μm, which is the measurement range of the particle diameter of toner particles, is divided into 256 segments, and the frequency value of the particle diameter of toner particles is calculated. The particle diameter of 50% particles from the largest volume integrated fraction is defined as a volume-based median diameter (D50).

### <Average Circularity of Toner Particles>

From the viewpoint of the stability of charging characteristics and low-temperature fixability, the average circularity of the toner particles is preferably in the range of 0.930 to 1.000, and more preferably in the range of 0.950 to 0.995.

When the average circularity is within the above range, both toner transferability and cleaning performance can be achieved, toner chargeability is stable, and a high-quality image can be formed.

The average circularity of the toner particles can be measured using, for example, a flow particle image analyzer “FPIA-3000” (manufactured by Sysmex Corporation).

Specifically, a toner sample to be measured is added to and mixed with a surfactant solution, diluted with pure water, and then subjected to ultrasound dispersion to prepare a toner particle dispersion. As the surfactant solution, for example, an anionic surfactant such as sodium polyoxyethylene lauryl ether sulfate is suitably used for the purpose of dispersing the toner particles. Then, for example, using a flow-type particle image analyzer “FPIA-3000” (manufactured by Sysmex Corporation), an image is captured at an appropriate density, i.e., an HPF detection number of 3,000 to 10,000, in a measurement condition of the HPF (high magnification imaging) mode.

The circularity of each of the toner particles is calculated using the following equation. Next, the average circularity is calculated by adding the circularity of each toner particle and dividing the sum by the total number of toner particles. When the number of HPF detections is within the above range, high reproducibility is obtained.

Circularity=(Perimeter of circle having the same projected area as particle image)/(Perimeter of particle projection image)

### <Toner Glass Transition Temperature>

From the viewpoint of achieving both sufficient low-temperature fixability and heat-resistant storage property, the glass transition temperature (Tg) of the toner is preferably within a range of 15 to 40° C. and more preferably within a range of 20 to 35° C. The glass transition temperature can be measured by the above-described method.

### <Core-Shell Structure>

The toner base particle may have a multilayer structure. Examples of the multilayer structure include a core-shell structure including a core particle and a shell layer covering the surface of the core particle.

The shell layer may not cover the entire surface of the core particle, or the core particle may be partially exposed. The cross-section of the core-shell structure can be confirmed by known observation methods such as transmission electron microscopy (TEM), scanning probe microscopy (SPM), etc. TEM (Transmission Electron Microscope), SPM (Scanning Probe Microscope), etc.

When the toner base particle has a core-shell structure, the core particle and the shell layer may have different properties in glass transition temperature, melting point, hardness, and the like, depending on the purpose. For example, core particles containing a binder resin, a coloring agent, a release agent, and the like and having a relatively low glass transition temperature (Tg) are prepared. Then, a resin having a relatively high glass transition temperature (Tg) is aggregated and fused with the core particles to form shell layers. The shell layers preferably contain an amorphous resin. Such a configuration allows for both low-temperature fixability and heat-resistant storage property. In addition, satisfactory charge retention performance is obtained.

[Method for Producing Toner] The toner can be produced in the same manner as a known toner by a pulverization method, an emulsion polymerization aggregation method, an emulsion aggregation method, a suspension polymerization method, or a dissolution suspension method, for example.

Among these, the pulverization method, the emulsion polymerization aggregation method, the emulsion aggregation method, or the suspension polymerization method is preferable, and the pulverization method or the emulsion polymerization aggregation method is more preferable.

In the emulsion aggregation method, for example, an aqueous dispersion of amorphous polyester fine particles, an aqueous dispersion of amorphous vinyl resin fine particles, a release agent, and a coloring agent are mixed. Then, these fine particles are aggregated to form wet toner base particle.

Then, in the present disclosure, wet toner base particle is dried under specific conditions to produce toner base particle.

The term “aqueous dispersion liquid” as used herein refers to a material in which dispersions (particles) are dispersed in an aqueous medium. The aqueous medium refers to a medium in which the main component, that is, a component occupying 50% by mass or more is water.

Examples of the components other than water contained in the aqueous medium include organic solvents that dissolve in water. As water-soluble organic solvents, examples include methanol, ethanol, isopropanol, butanol, acetone, methyl ethyl ketone, tetrahydrofuran, and the like.

Among these, from the viewpoint of not dissolving the resin, an alcohol-based organic solvent such as methanol, ethanol, isopropanol, and butanol are preferable.

Below, an example of a method for producing toner containing amorphous polyester and amorphous vinyl resin in the toner is shown, but the present disclosure is not limited thereto.
(1) Synthesizing an amorphous polyester to prepare a dispersion liquid of amorphous polyester fine particles step
(2) Synthesizing an amorphous vinyl resin and preparing a dispersion liquid of amorphous vinyl resin fine particles step
(3) A step of preparing a dispersion liquid of coloring agent fine particles
(4) A step of Aggregating amorphous polyester fine particles, amorphous vinyl resin fine particles, and coloring agent fine particles to form toner base particles
(5) A step of aging the toner base particle by thermal energy and controlling the shape
(6) a step of cooling a dispersion liquid of toner base particle
(7) A step of filtering toner base particle from an aqueous medium, washing the toner base particle to remove surfactant and the like, and obtaining wet toner base particle
(8) A step of desolventizing wet toner base particle
(9) A step of drying wet toner base particles by airflow in the dryer.
(10) A step of adding an external additive to dried toner base particle

### (1) Synthesizing an Amorphous Polyester to Prepare a Dispersion Liquid of Amorphous Polyester Fine Particles Step

In this step, the amorphous polyester is synthesized by a conventionally known method, and the amorphous polyester is dispersed in the form of fine particles in an aqueous medium to prepare a dispersion liquid of amorphous polyester fine particles.

Specifically, first, the amorphous polyester is dissolved or dispersed in an organic solvent to prepare an oil phase liquid. Next, the oil phase liquid is dispersed in an aqueous medium by phase inversion emulsification or the like to form oil droplets controlled to have a desired particle diameter. Thereafter, the organic solvent is removed to prepare an aqueous dispersion of amorphous polyester fine particles.

The usage amount of the aqueous medium used is preferably in a range of 50 to 2000% by mass and more preferably in a range of 100 to 1000% by mass with respect to the total mass of the oil phase liquid.

A surfactant or the like may be added to the aqueous medium from the viewpoint of the dispersion stability of the oil droplets. Examples of the surfactant include various conventionally known anionic surfactant, cationic surfactant, and nonionic surfactant.

From the viewpoint of removal treatment after formation of oil droplets, the organic solvent used in the preparation of the oil phase liquid preferably has a low boiling point and low solubility in water. Specific examples thereof include methyl acetate, ethyl acetate, methyl ethyl ketone, methyl isobutyl ketone, toluene, and xylene.

They may be used alone or in combination of two or more.

The usage amount of the organic solvent is preferably in the range of 1 to 300% by mass with respect to the total mass of the amorphous polyester.

The emulsification and dispersion of the oil phase liquid can be achieved using mechanical energy.

The amorphous polyester fine particles preferably have an average particle size in the range of 100 to 400 nm in terms of volume-based median size (D50). The volume-based median diameter (D50) can be measured using, for example, “microphoneotrac UPA-150” (manufactured by Nikkiso Co., Ltd).

### (2) A Step of Preparing a Dispersion Liquid of Non-Crystalline Vinyl Resin Fine Particles

The amorphous vinyl resin is synthesized by the above-mentioned conventional method. By adjusting the amount of chain transfer agent used during the synthesis of amorphous vinyl resin as described above, it is preferable to control the molecular weight and to control the molecular weight of the surface of the formed toner base particles.

By dispersing the synthesized amorphous vinyl resin in an aqueous medium in the form of fine particles, a dispersion liquid of amorphous vinyl resin particles is prepared.

Internal additives such as a release agent and a charge control agent may be contained in the toner base particle as necessary. Such an internal additive may be introduced into the toner base particle by previously dissolving or dispersing it in a monomer solution for synthesizing, for example, an amorphous polyester or an amorphous vinyl resin.

In cases where the release agent is not previously dissolved or dispersed in the monomer solution for synthesizing amorphous polyester or amorphous vinyl resin, a dispersion liquid of release agent fine particles may be separately prepared, and the dispersion liquid of the release agent fine particles may be added together with other resin particle dispersion liquid, and the particles may be aggregated as described below.

The aqueous dispersion liquid of the release agent fine particles can be prepared by dispersing the release agent in an aqueous medium to which a surfactant is added at a critical micelle concentration (CMC) or greater.

The release agent can be dispersed by utilizing mechanical energy. The disperser is not particularly limited, and examples thereof include ultrasound dispersers; mechanical homogenizers; pressurized dispersers such as Manton-Gaulin and pressure-type homogenizers; and medium-type dispersers such as a sand grinder and a diamond fine mill.

The volume-based median size (D50) of the release agent fine particles in a dispersed state is preferably in a range of 10 to 300 nm, more preferably in a range of 100 to 200 nm, and particularly preferably in a range of 100 to 150 nm. The volume-based median diameter (D50) of the release agent fine particles can be measured, for example, with an electrophoretic light scattering photometer “ELS-800” (manufactured by Otsuka Electronics Co., Ltd).

### (3) A Step of Preparing a Dispersion Liquid of Coloring Agent Fine Particles

The aqueous dispersion of coloring agent fine particles can be prepared in the same manner as the aqueous dispersion of release agent fine particles by the same sequence. The release agent fine particles are preferably heated to a melting point or higher for dispersion, but the coloring agent fine particles are not necessarily heated.

### (4) A Step of Aggregating Amorphous Polyester Fine Particles, Amorphous Vinyl Resin Fine Particles, and Coloring Agent Fine Particles to Form Toner Base Particles

In this step, a coagulant at or above the critical aggregation concentration is added to the aqueous dispersion liquid in which each fine particle is dispersed, and after these are aggregated to some extent, it is preferable to further add an additional dispersion liquid of amorphous polyester fine particles. These fine particles are fusion-bonded to control their shape to produce the toner base particle.

The coagulant is not particularly limited, but is preferably, for example, a metal salt such as an alkali metal salt or an alkaline earth metal salt. Metal salts include, for example, monovalent metal salts such as sodium, potassium, and lithium; divalent metal salts such as calcium, magnesium, manganese, and copper; and trivalent metal salts such as iron and aluminum.

Specific examples of the metal salt include sodium chloride, potassium chloride, lithium chloride, calcium chloride, magnesium chloride, zinc chloride, copper sulfate, magnesium sulfate, manganese sulfate, aluminum chloride, aluminum sulfate, polyaluminum chloride, and polyaluminum hydroxide. Among them, from the viewpoint that aggregation can be advanced with a smaller amount, it is preferable that it is a trivalent metal salt.

They may be used alone or in combination of two or more.

### (5) A Step of Aging the Toner Base Particle by Thermal Energy and Controlling the Shape

This step is performed as necessary when the toner base particle is aged by thermal energy to control its shapes.

Specifically, in the aging treatment, the dispersion liquid of the toner base particle is heated and stirred while adjusting the heating temperature, the stirring speed, the heating time, and the like, so that the circularity of the toner base particle becomes a desired value.

### (6) A Step of Cooling a Dispersion Liquid of Toner Base Particle

In this step, the dispersion liquid of the toner base particle is cooled. The cooling rate is preferably in a range of 1 to 20° C./min. The specific method of the cooling treatment is not particularly limited. The example methods include a cooling method by introducing a refrigerant from the outside of the reaction vessel, a cooling method by directly charging cold water into the reaction system, a cooling method by using a heat exchanger and the like.

(7) A Step of Filtering Toner Base Particle from an Aqueous Medium, Washing the Toner Base Particle to Remove Surfactant and the Like, and Obtaining Wet Toner Base Particle

In this step, the toner base particle are subjected to solid-liquid separation from the cooled dispersion liquid of the toner base particle. Next, the obtained toner cake is washed to remove adhered substances such as the surfactant and the coagulant, thereby obtaining wet toner base particle. The “toner cake” as used herein refers to an aggregate of wet toner base particle aggregation in a cake form.

The method of solid-liquid separation is not particularly limited, and examples thereof include centrifugation; a vacuum filtration method using a Nutsche filter or the like; and a filtration method using a filter press or the like. In the washing, the filtrate is preferably washed with water until the electrical conductivity of the filtrate becomes less than 10 μS/cm.

### (8) A Step of Desolventizing Wet Toner Base Particle

This step is performed as necessary when the amount of the solvent contained in the wet toner base particle is reduced.

By performing the desolvation treatment, the amount of the solvent contained in the obtained wet toner base particle can be reduced. In addition, the amount of the solvent contained in the obtained wet toner base particle can be adjusted by adjusting the time, rotation conditions, pressurization conditions, and the like in the desolvation treatment.

### (9) A Step of Drying Wet Toner Base Particle

In this step, the wet toner base particle subjected to the washing treatment and further subjected to the desolvation treatment in some cases is dried by a dryer.

Examples of the dryer include a spray dryer, a vacuum freeze dryer, and a reduced pressure dryer. In particular, it is preferable to use a stationary shelf dryer, a movable shelf dryer, a fluidized bed dryer, a rotary dryer, or a stirring dryer be used as the drier.

The water content of the dried toner base particle is preferably 5% by mass or less, and more preferably 2% by mass or less.

When the dried toner base particles are aggregation by a weak inter-particle attractive force, the aggregate may be subjected to crushing processing. Examples of the crushing processing apparatus include mechanical crushing apparatuses such as a jet mill, a Henschel mixer, a coffee mill, and a food processor.

The drying temperature is preferably in the range of 10 to 45° C., more preferably in the range of 20 to 40° C. If the drying temperature is higher than 45° C., the crystalline component in the toner is brought into a molten state, which makes it difficult to control the structure of the toner.

### (10) A Step of Adding an External Additive to Dried Toner Base Particle

This step adds the above-mentioned external additive to the toner base particle.

By adjusting the amount of external additive added to the toner base particle, the area ratio of the element derived from the above-mentioned inorganic fine particles can be set within a specific range. In addition, by adding an external additive, excellent fluidity, chargeability, and cleanability are achieved.

Examples of a device for mixing an external additive include mechanical mixing devices such as a Henschel mixer and a coffee mill.

The above steps (1) to (10) are examples of methods for producing toner base particles, and the present disclosure is not limited thereto.

The toner base particle according to the present disclosure may have a core-shell structure. The toner base particle having shell layers can achieve both low-temperature fixability and heat resistance. When forming the shell layer, it is preferable to form the shell layer after forming the core particles in step (4). The shell layer is preferably formed of an amorphous resin. A method for forming the shell layers is not particularly limited, and a conventionally known method can be used.

[white toner] The white toner used in the image forming method of the present disclosure contains at least a binder resin and a white pigment. Further, if necessary, additives known in the art other than binder resin and white pigment may be contained.

### <White Pigment>

As the white pigment, for example, particles such as titanium oxide, zinc oxide, barium sulfate, alumina, and calcium carbonate are preferably contained, and among these, it is preferable that titanium oxide particles are contained.

As the titanium oxide particles, it is particularly preferable that the surface of the titanium oxide particles is modified by a surface modifier. The particles of titanium oxide whose surface is modified by a surface modifier are hereinafter also referred to as “surface-modified titanium oxide particles.”

Here, surface modification includes both cases where apart of the surface of the particle is surface-modified and where the entire surface of the particle is surface-modified.

The titanium dioxide particles can be obtained by any of the production methods such as sulfuric acid method, chlorine method, etc. Crystal structures forming titanium dioxide particles include anatase, rutile, and brookite types. Among these, titanium dioxide particles with a rutile-type crystal structure are preferred, especially in terms of high Mohs hardness and resistance to abrasion.

As the material constituting the surface modification layer in surface-modified titanium oxide particles, there are no particular limitations as long as the effect of the present disclosure is not inhibited, but examples include antimony-doped tin oxide, aluminum hydroxide, silica, siloxane, and stearic acid. Among these, antimony-doped tin oxide is preferable in that it has conductivity and can prevent poor charging of toner.

The particle shape of the surface-modified titanium oxide particles can be said to be the same as the shape of the titanium oxide particles before surface modification. The shape of the surface-modified titanium oxide particles is not particularly limited, and examples include spherical, spindle-shaped, needle-shaped, and plate-shaped, with spherical or spindle-shaped being preferred.

The average primary particle diameter of surface-modified titanium oxide particles is determined by measuring the Feret diameter of 100 particles using a scanning electron microscope image and averaging the results. As for the particle size of titanium dioxide, 0.15 to 0.35 μm is preferred, and 0.2 to 0.3 μm is more preferred, since high whiteness and opacity can be obtained. Incidentally, the thickness of the surface modification layer depends on the type of surface modification layer, but for example, in the case of an antimony-doped tin oxide layer, it is about 5 to 20 nm, and 5 to 15 nm is more preferable.

As the surface-modified titanium oxide particles, commercially available ones can also be used. Commercially available surface-modified titanium dioxide particles include, for example, ET-500W, ET-600W, and ET-300W from Ishihara Sangyo Co. as titanium dioxide particles surface-modified with antimony-doped tin oxide.

The content of surface-modified titanium oxide particles in the white toner base particles is preferably within the range of 15 to 50% by mass with respect to the total amount of white toner base particles from the viewpoint of sufficiently exhibiting whiteness (opacity) without causing a decrease in chargeability, and more preferably within the range of 30 to 40% by mass. It is preferable that the amount is in the range of 40 to 80 parts by mass per 100 parts by mass of binder resin, and more preferably in the range of 50 to 80 parts by mass.

### <White Toner Binder Resin>

The binder resin used in the white toner is not particularly limited, but it is preferably contains an amorphous resin or a crystalline resin, and more preferably contains an amorphous resin.

Examples of amorphous resins used in white toner include vinyl resin, urethane resin, urea resin, and amorphous polyester resin. In the present disclosure, it is preferable to use a vinyl resin as the amorphous resin, and among vinyl resins, a styrene-acrylic resin is preferable. In addition, from the viewpoint of having a low viscosity and high sharp melt property, it is also preferable to use an amorphous polyester resin.

As the crystalline resin used for the white toner, conventionally known crystalline resin in this technical field can be used. As the crystalline resin, crystalline polyester resin is preferable.

Incidentally, the amorphous resin and crystalline resin used in the white toner can be the same as the amorphous resin and crystalline resin used in the colored toner described above, and therefore, the explanation thereof is omitted.

In addition to the binder resin and the white pigment, known additives (internal additives) contained therein can also be provided in the same manner as the additives (internal additives) in the toner base particles.

### <White Toner External Additive>

As external additives for white toner, inorganic fine particles, organic fine particles, lubricants, and the like can be mentioned, similarly to the external additives for colored toner. One of these may be used alone, or two or more may be used in combination. As the external additive for the white toner, silica particles or titanium oxide particles are more preferable.

The amount of external additive added to the white toner is preferably in the range of a total of 0.1 to 10.0 parts by mass based on 100 parts by mass of white toner base particles.

### Method for Producing White Toner

The white toner can be produced by manufacturing white toner base particles and adding an external additive to the obtained white toner base particles.

The white toner base particles can be produced in the same manner as the colored toner base particles, except that the colored coloring agent in the colored toner base particles is changed to a white pigment and the binder resin is appropriately changed. Regarding the volume average particle diameter and average circularity of the white toner base particles, it is preferable that the numerical range is similar to that of the colored toner base particles.

In addition, the content of binder resin in the white toner base particles is the amount obtained by subtracting the total content of white pigment and any internal additive from the total amount of white toner base particles.

The total content of the amorphous resin in the binder resin is preferably in the range of 70 to 90% by mass, and more preferably in the range of 80 to 90% by mass, based on the total amount of the binder resin.

With regard to the method of adding the above external additive to the white toner base particles, the same method as the method of adding the external additive to the colored toner base particles can be used.

[developer] Colored toner and white toner can be suitably used, for example, when used as a one-component magnetic toner containing a magnetic material, when mixed with a carrier and used as a two-component developer, or when a non-magnetic toner is used alone.

As the carrier constituting the two-component developer, magnetic particles made of conventionally known materials such as metals like iron, ferrite, and magnetite, alloys of these metals with other metals such as aluminum and lead, can be used. As the carrier, it is particularly preferable to use ferrite particles.

As for the carrier, those having a volume average particle diameter of 15 to 100 μm are preferable, and those in the range of 25 to 60 μm are more preferable.

As the carrier, it is preferable to use one further coated with resin, or a so-called resin-dispersed type carrier in which magnetic particles are dispersed in resin.

The resin composition for coating is not limited, but olefin-based resins, cyclohexyl methacrylate/methyl methacrylate copolymers, styrene-based resins, styrene acrylic resins, silicone-based resins, ester-based resins, or fluorine-containing polymerized resins are used, for example.

In addition, the resin for forming the resin-dispersed carrier is not particularly limited, and a known resin can be used. As the resin, for example, acrylic resin, styrene-acrylic resin, polyester resin, fluorine resin, phenol resin, and the like can be used.

A mixing device to be used for mixing the toner and the carrier is not particularly limited, and examples thereof include a Nauta mixer, a W-cone type mixer, and a V-type mixer.

The content of the toner in the developer is preferably in a range of 4.0 to 8.0% by mass with respect to the total mass of the developer.

[image forming apparatus] The present disclosure's image forming method is an electrophotographic method image forming method. The image forming method of the present disclosure is preferably used for an image forming apparatus (continuous printing machine) for continuous media, but may also be applied to an image forming apparatus that forms an image on a flat cut sheet. In particular, the image forming method of the present disclosure is suitably used for an image forming apparatus for continuous media from the viewpoint of effect manifestation.

An image forming method using an electrophotographic method preferably includes a step of attaching the toner to the recording medium and a step of fixing the attached toner to the recording medium. Furthermore, to improve image quality and durability, the image forming method preferably includes a step of applying varnish to the surface of the toner image formed by the fixing toner to form a varnish coat.

Hereinafter, an example of an electrophotographic method image forming apparatus will be described, but the present disclosure is not limited thereto.

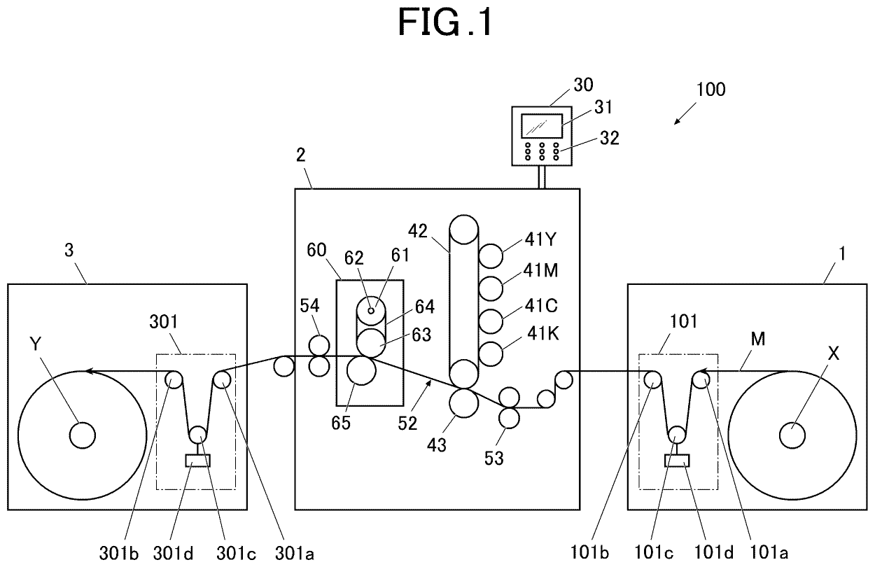

FIG. 1 is a diagram illustrating an example of the overall configuration of an image forming apparatus according to the present embodiment.

The image forming apparatus 100 shown in FIG. 1 is a device that forms an image on a recording medium such as a roll sheet or a continuous form as a continuous medium.

The image forming apparatus 100 is configured such that, along the conveyance direction (sheet conveyance direction) of the continuous medium M, from the upstream side, a sheet feed device (sheet feed section) 1, a main body section 2, and a winding device (winding section) 3 are connected. In FIG. 1, the sheet feed device 1 and the winding device 3 are shown as being configured separately from the main body section 2, but they may also be configured integrally.

The sheet feed device 1 is a device that feeds the continuous medium M to the main body section 2. The sheet feed device 1 conveys the continuous medium M wound around the support shaft X to the main body section 2 at a constant speed by driving a motor (not shown). The motor of the sheet feed device 1 is controlled by a controller 10 included in the main body section 2.

In addition, a sheet feed device 1 is provided with a tension applying mechanism 101 that applies tension to the continuous medium M.

The tension applying mechanism 101 includes driven roller 101a and 101b, a dancer roller 101c, and a weight 101d. The sheet-fed continuous medium M is wound around the driven roller 101a, dancer roller 101c, and driven roller 101b, and is passed through the main body section 2.

The main body section 2 forms an image on the continuous medium M fed from the sheet feed device 1 by an intermediate transfer method utilizing an electrophotographic method.

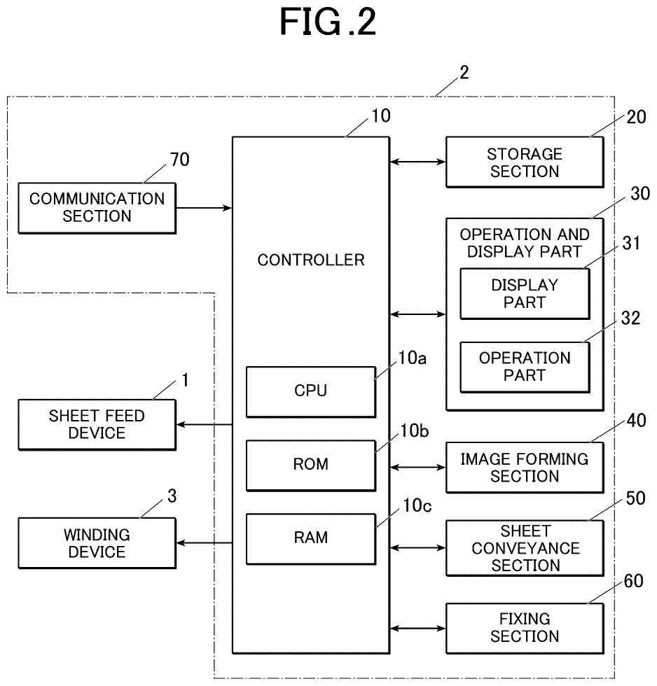

FIG. 2 is a diagram showing the main part of the control system of the image forming apparatus 100. As shown in FIG. 2, the main body section 2 includes a controller 10, a storage section 20, an operation and display part 30, an image forming section 40, a sheet conveyance section 50, a fixing section 60, a communication section 70, and the like.

The controller 10 includes a central processing unit (CPU) 10a, a read only memory (ROM) 10b, and a random access memory (RAM) 10c. The CPU 10a reads out a program according to the processing content from the ROM 10b and expands it in the RAM 10c, and, in cooperation with the expanded program, centrally controls the operation of each part of the main body section 2, the sheet feed device 1, the winding device 3, and the like.

The storage section 20 includes, for example, a nonvolatile semiconductor memory (so-called flash memory) and/or a hard disk drive. The storage section 20 stores input document data, various kinds of setting information, image data, and so forth. These data may be stored in the RAM 10c of the controller 10.

The operation and display part 30 is configured, for example, with a liquid crystal display (LCD: Liquid Crystal Display) with a touch screen, and functions as a display part 31 and an operation part 32.

The display part 31 displays various kinds of operation screens, the state of images, operating status of the respective functions, and so forth in accordance with display control signals received from the controller 10.

The operation part 32 includes various kinds of operation keys such as numeric keypad and a start key. The operation part 32 receives various input operations by a user and outputs operation signals to the controller 10.

The image forming section 40 forms, for example, based on image data input from an external device (such as a personal computer) via the communication section 70, toner images of each color Y (yellow), M (magenta), C (cyan), and K (black) on the photosensitive drums 41Y, 41M, 41C, and 41K, sequentially performs primary transfer onto the intermediate transfer belt 42 to superimpose the four toner images, and then, by secondary transfer onto the continuous medium M fed from the sheet feed device 1 by the transfer roller 43, forms (prints) an image.

The sheet conveyance section 50 includes a sheet feed path 52 including a plurality of conveyance rollers.

The sheet conveyance section 50 conveys the continuous medium M, which has been conveyed from the sheet feed device 1 to the main body section 2 under the control of the controller 10, to the image forming section 40, and conveys the continuous medium M, on which a toner image has been formed in the image forming section 40, to the fixing section 60. Then, the continuous medium M on which the toner image has been fixed in the fixing section 60 is conveyed to the winding device 3.

At least a pair of nip rollers 53 is provided upstream of the fixing section 60 and downstream of the sheet feed device 1 in the sheet feed path 52. Further, at least a pair of nip rollers 54 is provided downstream of the fixing section 60 and upstream of the winding device 3. The nip roller 53 and 54 can be pressed against and separated from each other by a pressing drive mechanism. By pressing both nip rollers 53 and 54 while tension is applied to the continuous medium M by the tension applying mechanism 101 and the tension applying mechanism 301, it is possible to maintain the tension applied to the continuous medium M between the nip rollers 53 and 54 even if the rotation of the rollers is stopped and the tension application by the tension applying mechanisms 101 and 301 is released.

The fixing section 60 heats and presses the continuous medium M with a fixing nip to fix the toner image formed on the continuous medium M onto the continuous medium M.

The fixing section 60 includes a heating roller 61, a heating source 62 that heats the heating roller 61, an upper pressure roller 63, an endless fixing belt 64 stretched around the heating roller 61 and the upper pressure roller 63, and a lower pressure roller 65. The heating roller 61 to the fixing belt 64 are provided on the fixing surface side of the continuous medium M, and the lower pressure roller 65 is provided so as to face the fixing belt 64 across the sheet conveying path 52 of the continuous medium M (that is, on the back surface side of the continuous medium M). There may be a heating source for heating the lower pressure roller 65.

The lower pressure roller 65 is movable, and the upper pressure roller 63 and the lower pressure roller 65 can be brought into pressure contact with each other and separated from each other by a not-illustrated drive mechanism.

By pressing and separating the upper pressure roller 63 and the lower pressure roller 65, it is possible to press and separate the fixing belt 64 and the lower pressure roller 65. A fixing belt 64 and a lower pressure roller 65 are pressed together to form a fixing nip that holds and conveys the continuous medium M. The continuous medium M is heated and pressurized as it passes through the fixing nip formed by the fixing belt 64, which is heated by the heating source 62, and the lower pressure roller 65, and the toner image is fixed.

The communication section 70 is constituted by, for example, a communication control card such as a LAN (Local Area Network) card, and is connected to a communication network such as a LAN or WAN (Wide Area Network).

For example, various data is transmitted and received between a computer and the device.

The winding device 3 is a device that winds a continuous medium M conveyed from the main body section 2. The winding device 3 winds the continuous medium M, which has been conveyed from the main body section 2, onto the support shaft Y at a constant speed by driving a motor (not shown). The winding operation of the winding device 3 is controlled by the controller 10 of the main body section 2.

Further, a winding device 3 is provided with a tension applying mechanism 301 that applies tension to the continuous medium M. The tension applying mechanism 301 includes driven roller 301a and 301b, a dancer roller 301c, and a weight 301d. The continuous medium M conveyed from the main body section 2 is wound around the driven roller 301a, dancer roller 301c, and driven roller 301b, thereby being provided with tension and conveyed to the support shaft Y.

In the present embodiment, the sheet feed device 1 and the winding device 3 each include a tension applying mechanism. However, only either of them may include a tension applying mechanism.

The above-described apparatus configuration and image forming method are exemplary embodiments for carrying out the present disclosure, and the present disclosure is not limited thereto.

### EXAMPLE

Hereinafter, the present disclosure will be specifically described with reference to examples, but the present disclosure is not limited thereto. Note that in the following Examples, operations were performed at room temperature (25° C.) unless otherwise specified. Further, unless otherwise specified, “%” and “parts” mean “% by mass” and “parts by mass”, respectively.

### <Preparation of Binder Resin Fine Particle Dispersion (SA1)>

(1) First Stage Polymerization (Preparation of Dispersion Liquid of Resin Fine Particles (a1))

A stirrer, temperature sensor, temperature control device, cooling tube, and nitrogen introduction device are attached to the reaction vessel. An anionic surfactant solution, in which 2.0 parts by mass of an anionic surfactant “sodium lauryl sulfate” is dissolved in 2900 parts by mass of ion-exchanged water, is charged into the reaction vessel in advance. And while stirring at a stirring speed of 230 rpm under a nitrogen gas airflow, the internal temperature was raised to 80° C. 9.0 parts by mass of a polymerization initiator, potassium persulfate (KPS), was added to this anionic surfactant solution, and after the internal temperature was set to 78° C., a monomer solution (1-1) having the following composition was dropped over 3 hours.

| | | |
|---|---|---|
| Styrene | 560 | parts by mass |
| n-butyl acrylate | 162 | parts by mass |
| Methacrylic acid | 82 | parts by mass |
| n-octyl mercaptan | 20 | parts by mass |

After completion of dropping, a dispersion liquid of resin fine particles (a1) was prepared by performing polymerization (first stage polymerization) by heating and stirring for 1 hour at 78° C.

(2) Second Stage Polymerization: Formation of Intermediate Layer (Preparation of Resin Fine Particle (all) Dispersion Liquid)

In a flask equipped with a stirring device, 51 parts by mass of behenyl behenate (ester wax, melting point: 78° C.) was added to the solution having the following composition as a release agent. Then, the mixture was heated to 85° C. to dissolve it and prepare the monomer solution (1-2).

| | | |
|---|---|---|
| Styrene | 100 | parts by mass |
| n-butyl acrylate | 30 | parts by mass |
| Methacrylic acid | 6 | parts by mass |
| n-octyl mercaptan | 2 | parts by mass |

On the other hand, a surfactant solution prepared by dissolving 2 parts by mass of an anionic surfactant “sodium lauryl sulfate” in 1100 parts by mass of ion-exchanged water was heated to 90° C. A dispersion liquid of resin particles (a1) was added to this surfactant solution in an amount of 28 parts by mass in terms of the solid content of the resin particles (a1). Thereafter, a dispersion liquid containing emulsion particles having a dispersed particle diameter of 350 nm was prepared by mixing and dispersing the above monomer solution (1-2) for 4 hours using a mechanical disperser “Creamix” (manufactured by M Technique Co., Ltd.) having a circulation path. To this dispersion liquid, an initiator aqueous solution prepared by dissolving 2.5 parts by mass of polymerization initiator “KPS” in 110 parts by mass of ion-exchanged water was added. By heating and stirring this system at 90° C. for 2 hours to perform polymerization (second stage polymerization), a resin fine particle (a11) dispersion liquid was prepared.

### (3) Third Stage Polymerization: Formation of Outer Layer

To the above resin fine particle dispersion liquid (a11), a polymerization initiator “KPS” 2.5 parts by mass was added to an initiator aqueous solution prepared by dissolving in ion-exchanged water 110 parts by mass. At a temperature condition of 80° C., a monomer solution (1-3) having the following composition was dropped over one hour.

| | | |
|---|---|---|
| Styrene | 240 | parts by mass |
| n-butyl acrylate | 82 | parts by mass |
| Methacrylic acid | 17 | parts by mass |
| n-octyl mercaptan | 5.5 | parts by mass |

After the drop was completed, polymerization (third stage polymerization) was carried out by heating and stirring for 3 hours. Thereafter, it was cooled to 28° C., and a dispersion liquid (SA1) of binder resin fine particles (A1) dispersed in an anionic surfactant solution was prepared.

### <Preparation of Binder Resin Fine Particle Dispersion (SA2) to (SA7)>

Except for changing the amount of n-octyl mercaptan used and the type of release agent as shown in Table I, binder resin fine particle dispersion (SA2) to (SA7) were prepared in the same manner as the preparation of binder resin fine particle dispersion (SA1). The addition amount of each release agent is the same as (SA1).

TABLE I

| BINDER RESIN | n-OCTYL MERCAPTAN AMOUNT | | | |
|---|---|---|---|---|
| FINE PARTICLE | (PARTS BY MASS) | | | RELEASE |
| DISPERSION | FIRST STAGE | SECOND STAGE | THIRD STAGE | AGENT |
| No. | POLYMERIZATION | POLYMERIZATION | POLYMERIZATION | TYPE |
| SA1 | 20 | 2 | 5.5 | BEHENYL BEHENATE |
| | | | | (ESTER WAX) |
| SA2 | 20 | 2.4 | 7 | BEHENYL BEHENATE |
| | | | | (ESTER WAX) |
| SA3 | 20 | 1 | 2.5 | BEHENYL BEHENATE |
| | | | | (ESTER WAX) |
| SA4 | 20 | 2 | 5.5 | PARAFFIN WAX |
| | | | | (HYDROCARBON WAX) |
| SA5 | 20 | 3.6 | 10 | BEHENYL BEHENATE |
| | | | | (ESTER WAX) |
| SA6 | 20 | 2 | 5.5 | FISCHER-TROPSCH WAX |
| | | | | (HYDROCARBON WAX) |
| SA7 | 20 | 2 | 5.5 | SEBACIC ACID STEARYL |
| | | | | (DIESTER WAX) |

### <Preparation of Amorphous Polyester Resin Fine Particle Dispersion (PB1)>

### (1) Amorphous Polyester Resin (Styrene-Acrylic Modified Polyester Resin (B1)) Synthesis

Each compound shown below was placed in a four-necked flask with a capacity of 10 liters equipped with a nitrogen introduction tube, a dehydration tube, a stirrer, and a thermocouple, and a shrinkage polymerization reaction was carried out at 230° C. for 8 hours. The reaction was further carried out at 8 kPa for 1 hour and cooled to 160° C.

| | | |
|---|---|---|
| Bisphenol A propylene oxide 2-mole adduct | 500 | parts by mass |
| terephthalic acid | 117 | parts by mass |
| fumaric acid | 82 | parts by mass |
| Esterification catalyst (octyltin) | 2 | parts by mass |

Then, a mixture consisting of the compositions shown below was added dropwise over a period of 1 hour by a dropping funnel. After dropping, the addition polymerization reaction was continued for 1 hour while maintaining at 160° C., then the temperature was raised to 200° C. and maintained at 10 kPa for 1 hour. Thereafter, by removing acrylic acid, styrene, and butyl acrylate, a styrene-acrylic modified polyester resin (B1) was obtained.

| | | |
|---|---|---|
| Acrylic acid | 10 | parts by mass |
| Styrene | 30 | parts by mass |
| butyl acrylate | 7 | parts by mass |
| Polymerization initiator (di-t-butyl peroxide) | 10 | parts by mass |

The glass transition point of this styrene-acrylic modified polyester resin (B1) was 60° C., and the softening point was 105° C.

### (2) Preparation of Amorphous Polyester Resin Fine Particle Dispersion (AB1)

100 parts by mass of the obtained styrene-acrylic modified polyester resin (B1) were pulverized with a “Randell Mill, Model: RM” (manufactured by Tokujyu Kousakusho Co., Ltd.). A 0.26 mass % sodium lauryl sulfate solution, 638 parts by mass, which had been prepared in advance, was mixed with this. While stirring, ultrasound dispersion was performed for 30 minutes at V-LEVEL, 300 μA using an ultrasonic homogenizer “US-150T” (manufactured by Nippon Seiki Seisakusho). As a result, a dispersion liquid (AB1) in which amorphous polyester resin fine particles (B1) having a volume-based median diameter (D₅₀) of 250 nm are dispersed was prepared.

### <Preparation of Coloring Agent Particle Dispersion (P1)>

While stirring a solution prepared by adding 90 parts by mass of sodium dodecyl sulfate to 1600 parts by mass of ion-exchanged water, 420 parts by mass of copper phthalocyanine (C.I. Pigment Blue 15:3) was gradually added.

Subsequently, the obtained dispersion liquid was subjected to dispersion treatment using a stirring device “Creamix” (manufactured by M-Technic Co., Ltd.), thereby preparing a coloring agent particle dispersion liquid (P1). The coloring agent particles in the dispersion liquid had a volume-based median diameter of 120 nm.

<Preparation of White Coloring agent Particle Dispersion (P2)>

0.1 mol/L hydrochloric acid aqueous solution was added to 1000 parts by mass of ion-exchanged water and the pH was adjusted to 4.5. Thereafter, 300 parts by mass of ET-500W (manufactured by Ishihara Sangyo Kaisha, Ltd.), which are titanium oxide particles as white colored particles, and 3 parts by mass of an anionic surfactant (manufactured by Daiichi Kogyo Seiyaku Co., Ltd., Neogen RK) were added.

Subsequently, a homogenizer (Ultraturrax T50: Ika-Werke GmbH & Co. KG) was used to disperse for 5 minutes in a round stainless steel flask to obtain a white coloring agent particle dispersion (P2).

ET-500W is a surface-modified titanium dioxide particle in which spherical titanium dioxide particles with rutile-type crystal structure (average primary particle diameter; 200 nm, Mohs hardness; 7.5) are surface-modified by antimony-doped tin oxide. Incidentally, the thickness of the surface modification layer is so thin as to be negligible relative to the particle diameter of the titanium oxide particles.

### <Preparation of Cyan Toner>

### (Preparation of Cyan Toner (1))

In a reaction vessel equipped with a stirring device, temperature sensor and cooling tube, 288 parts by mass (on a solid basis) of binder resin fine particle dispersion (SA1) and 2000 parts by mass of ion-exchanged water were charged. The pH was adjusted to 10 by adding 5 moles/liter of sodium hydroxide solution.

Thereafter, 40 parts by mass of the coloring agent particle dispersion (P1) was added in terms of solid content. Then, an aqueous solution prepared by dissolving 60 parts by mass of magnesium chloride in 60 parts by mass of ion-exchanged water was added at 30° C. over 10 minutes under stirring.

Thereafter, after leaving it to stand for 3 minutes, the temperature was raised, and the system was heated to 80° C. over 60 minutes. Upon reaching 80° C., 40 parts by mass (in terms of solids) of the amorphous polyester resin fine particle dispersion (AB1) (first time) was added over 10 minutes. After that, the particle growth reaction was continued while maintaining 80° C.

In this state, the particle diameter of the core particles was measured using the “Coulter Multisizer 3” (manufactured by Beckman Coulter). When the volume-based median diameter (D₅₀) reached 6.0 μm, 32 parts by mass of the dispersion of amorphous polyester resin fine particle dispersion (AB1) (second time) was added over 30 minutes in terms of solid content. When the supernatant of the reaction solution became clear, a solution prepared by dissolving 190 parts by mass of sodium chloride in 760 parts by mass of ion-exchanged water was added to stop particle growth.

Furthermore, the temperature was raised, and fusion of the particles was allowed to proceed by heating and stirring in a state of 90° C. Using the “FPIA-2100” (manufactured by Sysmex) measurement apparatus for the average circularity of toner (with 4000 HPF detections), when the average circularity reached 0.945, it was cooled to 30° C. to obtain a dispersion liquid of cyan toner base particle (1).

The dispersion liquid of the cyan toner base particle (1) was subjected to solid-liquid separation by a centrifuge to form a wet cake of the cyan toner base particle. This was washed with ion-exchanged water at 35° C. using a centrifuge until the electrical conductivity of the filtrate reached 5 μS/cm. Thereafter, it was transferred to a “Flash Jet Dryer” (manufactured by Seishin Enterprise Co., Ltd.) and dried until the moisture content became 0.5% by mass.

Hydrophobic silica particles (number average primary particle diameter=12 nm) 1% by mass and hydrophobic aluminum oxide particles (number average primary particle diameter=18 nm) 0.3% by mass were added to the dried cyan toner base particle (1). By mixing using a Henschel mixer, a cyan toner (1) was prepared.

The hydrophobic silica particles are silica particles that have been hydrophobically treated with hexamethyldisilazane.

The hydrophobic aluminum oxide particles are aluminum oxide particles hydrophobically treated with alkylsilane (4 carbons).

### (Preparation of Cyan Toner (2) to (15))

In the method for producing cyan toner (1), cyan toners (2) to (15) were produced in the same manner as the production of cyan toner (1), except that the amount of the binder resin fine particle dispersion and the amorphous polyester resin fine particle dispersion to be used, and the type and amount of the external additive were as shown in Table II.

The hydrophobic silica described in the table is the same as the hydrophobic silica particles used in the preparation of cyan toner (1).

The hydrophobic titanium oxide listed in the table is hydrophobic titanium dioxide particles with a number-average primary particle size of 20 nm. The hydrophobic titanium oxide particles are hydrophobically treated with isobutyltrimethoxysilane.

TABLE II

| | | | | | | | AMORPHOUS | |
|---|---|---|---|---|---|---|---|---|
| | | | | | | | POLYESTER RESIN FINE | |
| | BINDER | | | | | | PARTICLE DISPERSION | |
| | RESIN | | | | | | (AB1) | |
| | FINE | | EXTERNAL ADDITIVE 1 | | EXTERNAL ADDITIVE 2 | | FIRST | SECOND |
| CYAN | PARTICLE | | | AMOUNT | | AMOUNT | TIME | TIME |
| TONER | DISPER- | | | [% BY | | [% BY | [PARTS | [PARTS |
| No. | SION No. | RELEASE AGENT | TYPE | MASS] | TYPE | MASS] | BY MASS] | BY MASS] |
| TONER | SA1 | BEHENYL BEHENATE | HYDROPHOBIC | 1.0 | HYDROPHOBIC | 0.3 | 40.0 | 32.0 |
| 1 | | (ESTER WAX) | SILICA | | ALUMINUM OXIDE | | | |
| TONER | SA2 | BEHENYL BEHENATE | HYDROPHOBIC | 1.0 | HYDROPHOBIC | 0.3 | 40.0 | 32.0 |
| 2 | | (ESTER WAX) | SILICA | | TITANIUM OXIDE | | | |
| TONER | SA3 | BEHENYL BEHENATE | HYDROPHOBIC | 1.8 | HYDROPHOBIC | 0.5 | 40.0 | 32.0 |
| 3 | | (ESTER WAX) | SILICA | | TITANIUM OXIDE | | | |
| TONER | SA4 | PARAFFIN WAX | HYDROPHOBIC | 1.0 | HYDROPHOBIC | 0.3 | 40.0 | 32.0 |
| 4 | | (HYDROCARBON WAX) | SILICA | | TITANIUM OXIDE | | | |
| TONER | SA4 | PARAFFIN WAX | HYDROPHOBIC | 1.3 | HYDROPHOBIC | 0.4 | 20.0 | 16.0 |
| 5 | | (HYDROCARBON WAX) | SILICA | | TITANIUM OXIDE | | | |
| TONER | SA4 | PARAFFIN WAX | HYDROPHOBIC | 1.3 | HYDROPHOBIC | 0.4 | 100.0 | 80.0 |
| 6 | | (HYDROCARBON WAX) | SILICA | | TITANIUM OXIDE | | | |
| TONER | SA4 | PARAFFIN WAX | HYDROPHOBIC | 1.3 | HYDROPHOBIC | 0.4 | 100.0 | 80.0 |
| 7 | | (HYDROCARBON WAX) | SILICA | | TITANIUM OXIDE | | | |
| TONER | SA4 | PARAFFIN WAX | HYDROPHOBIC | 1.3 | HYDROPHOBIC | 0.4 | 100.0 | 80.0 |
| 8 | | (HYDROCARBON WAX) | SILICA | | TITANIUM OXIDE | | | |
| TONER | SA1 | BEHENYL BEHENATE | HYDROPHOBIC | 1.3 | HYDROPHOBIC | 0.4 | 18.0 | 14.4 |
| 9 | | (ESTER WAX) | SILICA | | TITANIUM OXIDE | | | |
| TONER | SA1 | BEHENYL BEHENATE | HYDROPHOBIC | 1.3 | HYDROPHOBIC | 0.4 | 102.0 | 81.6 |
| 10 | | (ESTER WAX) | SILICA | | TITANIUM OXIDE | | | |
| TONER | SA3 | BEHENYL BEHENATE | HYDROPHOBIC | 1.3 | HYDROPHOBIC | 0.4 | 40.0 | 32.0 |
| 11 | | (ESTER WAX) | SILICA | | TITANIUM OXIDE | | | |
| TONER | SA6 | FISCHER-TROPSCH | HYDROPHOBIC | 1.3 | HYDROPHOBIC | 0.4 | 100.0 | 80.0 |
| 12 | | WAX | SILICA | | TITANIUM OXIDE | | | |
| | | (HYDROCARBON WAX) | | | | | | |
| TONER | SA7 | SEBACIC ACID | HYDROPHOBIC | 1.3 | HYDROPHOBIC | 0.4 | 18.0 | 14.4 |
| 13 | | STEARYL | SILICA | | TITANIUM OXIDE | | | |
| | | (DIESTER WAX) | | | | | | |
| TONER | SA1 | BEHENYL BEHENATE | HYDROPHOBIC | 0.7 | HYDROPHOBIC | 0.2 | 40.0 | 32.0 |
| 14 | | (ESTER WAX) | SILICA | | TITANIUM OXIDE | | | |
| TONER | SA3 | BEHENYL BEHENATE | HYDROPHOBIC | 2.0 | HYDROPHOBIC | 0.6 | 40.0 | 32.0 |
| 15 | | (ESTER WAX) | SILICA | | TITANIUM OXIDE | | | |

### <Preparation of White Toner (W1)>

A stirrer, cooling tube, and thermometer were attached to the reaction vessel. In the reaction vessel, 200 parts by mass (in terms of solid content) of the binder resin fine particle dispersion (SA1), 30 parts by mass (in terms of solid content) of the amorphous polyester resin fine particle dispersion (AB1), 175 parts by mass (in terms of solid content) of the white coloring agent particle dispersion (PB2), 0.5 parts by mass of an aqueous solution of polyoxyethylene lauryl ether sodium sulfate, and 100 parts by mass of ion-exchanged water were added. The pH was adjusted to 2.5 by adding 0.1 N hydrochloric acid while stirring.

Next, 0.4 parts by mass of polyaluminum chloride aqueous solution (10% aqueous solution in terms of AlCl₃) was dropped over 10 minutes. Thereafter, the temperature was raised at a rate of 0.05° C./min while stirring, and the particle diameter of the aggregated particles was measured as appropriate using the “Multisizer 3” (manufactured by Beckman Coulter, Inc.). When the volume average particle diameter (volume-based median diameter) of the aggregation particles reached 5.0 μm, the temperature was raised, and the pH was adjusted to 7 using a 0.05 (mol/L) sodium hydroxide aqueous solution while stirring. Thereafter, the internal temperature was further raised to 85° C., and when the average circularity reached 0.960 using FPIA-2100 (manufactured by Sysmex), the mixture was cooled to room temperature at a rate of 10° C./min. By repeating filtration and washing of this reaction solution, and then drying, white toner base particles were obtained.

To 100 parts by mass of the prepared white toner base particles, 0.5% by mass of silica particles and 0.5% by mass of titanium oxide particles were added, and the mixture was added to a Henschel mixer model “FM20C/I” (manufactured by Nippon Coke & Engineering Co., Ltd.). Then, the rotation speed was set so that the blade tip peripheral speed was 60 m/s, and stirring was performed for 20 minutes to produce “white toner (W1)” consisting of white toner particles.

In addition, the product temperature during external addition mixing was set to 40° C.±1° C., and when it reached 41° C., cooling water was supplied to the external bath of the Henschel mixer at a flow rate of 5 L/min. When the temperature reached 39° C., temperature control inside the Henschel mixer was performed by flowing cooling water at a rate of 1 L/min.

Incidentally, the silica particles and titanium oxide particles added to the white toner base particles are the same as the hydrophobic silica particles and hydrophobic titanium oxide particles used in the production of cyan toner, respectively.

### <White Toner (W2) and (W3) Production>

In the method for producing white toner (W1), except that the binder resin fine particle dispersion (SA1) used was as shown in Table III, white toner (W2) and (W3) were produced in the same manner as the production of white toner (W1).

TABLE III

| | BINDER RESIN FINE |
|---|---|
| WHITE TONER | PARTICLE DISPERSION |
| No. | No. |
| WHITE TONER W1 | SA1 |
| WHITE TONER W2 | SA5 |
| WHITE TONER W3 | SA3 |

### <Preparation of Developer>

### (1) Preparation of Carrier

100 parts by mass of ferrite core and 5 parts by mass of cyclohexyl methacrylate/methyl methacrylate (copolymerization ratio 5/5) copolymer resin particles were charged into a high-speed mixer equipped with stirring blades. By stirring and mixing at 120° C. for 30 minutes, a resin coat layer was formed on the surface of the ferrite core by the action of mechanical impact force, thereby obtaining a carrier having a volume-based median diameter of 50 μm.

The median diameter based on the volume of the carrier was measured using a laser diffraction particle size distribution measuring device “HELOS” (manufactured by Sympatec Co., Ltd.) equipped with a wet dispersion machine.

### (2) Toner and Carrier Mixing

For each of the toners (cyan toner 1 to 15, white toner W1 to W3), the above carrier was added so that the toner concentration became 6%. By mixing with a micro-type V-type mixer (Tsutsui Rikagaku Kikai Co., Ltd.) at a rotational speed of 45 rpm for 30 minutes, cyan developers (1) to (15) and white developers (W1) to (W3) were produced.

### [Evaluation]

### <Separability>

As an image forming apparatus for continuous media, “AccurioLabel 400” (manufactured by Konica Minolta) was used, and this apparatus was equipped with the above two-component developer as the developer. Under an environment of normal temperature and normal humidity (temperature 22° C., humidity 50% RH), image formation was performed using N Mirror 73/P22/L8W (manufactured by Oji Tack Co., Ltd.) as the printing medium, and the toner adhesion amount was adjusted to be Table IV in the image before fixing.

Thereafter, the surface temperature of the fixing heating member was set to 200° C., and an image was output.

As shown in Table IV, examples 1 to 4 and comparative examples 1 and 2 were subjected to image formation using a cyan developer, and examples 5 to 13 were subjected to image formation using a white developer followed by image formation using a cyan developer.

The streaks on the image surface caused by poor fixing separation in the direction perpendicular to the sheet feeding direction were visually evaluated. R2 to R4 were accepted in the following criteria.

### (Standard)

R4: No streak generated
R3: A slight streak is visible from a specific angle
R2: streak is visible from a specific angle
R1: A clear streak can be seen from any angle.

### <Low-Temperature Fixability>

As an image forming apparatus for continuous media, “AccurioLabel 400” (manufactured by Konica Minolta) was used, and this apparatus was equipped with the above two-component developer as the developer. Under an environment of normal temperature and normal humidity (temperature 22° C., humidity 50% RH), image formation was performed using N Mirror 73/P22/L8W (manufactured by Oji Tac) as the printing medium, and the toner adhesion amount was adjusted to the value in Table IV in the image before fixing.

Subsequently, the surface temperature of the fixing heating member was changed in increments of 5° C. within the range from 120° C. to 200° C., and an image was fixed at each temperature.

As shown in Table IV, examples 1 to 4 and comparative examples 1 and 2 were subjected to image formation using a cyan developer, and examples 5 to 10 were subjected to image formation using a white developer followed by image formation using a cyan developer.

A visual evaluation was performed on the image obtained, and the temperature at which no offset occurred was defined as the minimum fixing temperature. R3 to R5 were accepted in the following criteria.

### (Standard)

R5: The minimum fusing temperature is less than 150° C.
R4: The minimum fusing temperature is between 150° C. and 160° C.
R3: The minimum fusing temperature is between 160° C. and 170° C.
R2: The minimum fusing temperature is between 170° C. and 180° C.
R1: The minimum fusing temperature is 180° C. or higher.

### <Varnish Coatability>

As an image forming apparatus for continuous media, “AccurioLabel 400” (manufactured by Konica Minolta) was used, and this apparatus was equipped with the above two-component developer as the developer. Under an environment of normal temperature and normal humidity (temperature 22° C., humidity 50% RH), image formation was performed using N Mirror 73/P22/L8W (manufactured by Oji Tac) as the printing medium. The toner adhesion amount in the pre-fixing image was adjusted to the value in Table IV, the surface temperature of the fixing heating member was set to 200° C., and the image was output. As shown in Table IV, examples 1 to 4 and comparative examples 1 and 2 were subjected to image formation using a cyan developer, and examples 5 to 10 were subjected to image formation using a white developer followed by image formation using a cyan developer.

UV VECTA coat varnish PC-3KW2 (manufactured by T&K) was applied to the fused image using a bar coater to achieve a thickness of 5 μm.

The varnish was then cured to form the varnish layer by irradiating it with ultraviolet light using a high-pressure mercury vapor lamp so that the integrated light intensity on the image surface was 120 to 130 mJ/cm². UV VECTA Coatniss PC-3KW2 contains a polymerizable monomer for varnish and a photopolymerization initiator (radical polymerization initiator). The polymerizable monomer for varnish has a polymerizable functional group containing an ethylenic double bond.

The surface of the varnish layer of the obtained image was visually observed, and the coating property was evaluated based on the presence or absence of pinholes or repellency according to the following criteria. R2 to R4 were accepted in the following criteria.

### (Standard)

R4: No pinholes in an area of 10 cm×10 cm.
R3: At least one but no more than two microscopic pinholes in an area of 10 cm×10 cm.
R2: Three to 10 microscopic pinholes in an area of 10 cm×10 cm.
R1: Equal to or more than 11 pinholes or bursting in an area of 10 cm×10 cm.
   <Area Ratio of Elements Derived from Inorganic Fine Particles>

Regarding the image output in the evaluation method of the <varnish coatability>, the area ratio of elements derived from inorganic fine particles to the total area of all elements measured by X-ray photoelectron spectroscopy (ESCA) was calculated. The results are shown in Table IV below.

K-Alpha (Thermo Fisher Scientific) was used as the X-ray photoelectron spectrometer, and the following measurement conditions were used.

The peak area of carbon element (peak area C) present within 3 nm from the outermost surface of the toner particles, the peak area of oxygen element (peak area O), and the peak area of the element derived from the inorganic fine particles were identified.

The peak areas of the inorganic particle-derived elements are the peak area of the silicon element and the peak area of the titanium element.

Each peak area was identified from its respective atomic peak area using a relative sensitivity factor. From each peak area obtained, the area ratio of inorganic particulate-derived elements to the area of all elements was calculated based on the following formula A.

$$( Total peak area of inorganic particulate ‐ derived elements / ( Peak area C + Peak area O + Total peak area of inorganic paticulate ‐ derived elements ) \times 100 \qquad formula A$$

### (Measurement Condition)

X-ray: Al monochrome source
Acceleration: 12 kV, 6 mA
Resolution: 50 eV
Beam-based: 400 μm
Path Energy: 50 eV
Step Size: 0.1 eV

TABLE IV

| | | | | SOFTENING POINT [° C.] | | |
|---|---|---|---|---|---|---|
| | | | AMORPHOUS | CYAN | WHITE | DIFFERENCE |
| | | | POLYESTER | TONER | TONER | IN |
| | DEVELOPER USED | | CONTENT | SOFTENING | SOFTENING | SOFTENING |
| | CYAN | WHITE | [% BY MASS] | POINT | POINT | POINT |
| EXAMPLE | DEVELOPER | NONE | 20 | 114 | — | — |
| 1 | 1 | | | | | |
| EXAMPLE | DEVELOPER | NONE | 20 | 116 | — | — |
| 2 | 2 | | | | | |
| EXAMPLE | DEVELOPER | NONE | 20 | 119 | — | — |
| 3 | 3 | | | | | |
| EXAMPLE | DEVELOPER | NONE | 20 | 113 | — | — |
| 4 | 4 | | | | | |
| EXAMPLE | DEVELOPER | DEVELOPER | 10 | 113 | 106 | 7 |
| 5 | 5 | W1 | | | | |
| EXAMPLE | DEVELOPER | DEVELOPER | 50 | 113 | 106 | 7 |
| 6 | 6 | W1 | | | | |
| EXAMPLE | DEVELOPER | DEVELOPER | 50 | 113 | 89.5 | 13.5 |
| 7 | 7 | W2 | | | | |
| EXAMPLE | DEVELOPER | DEVELOPER | 50 | 113 | 113 | 0 |
| 8 | 8 | W3 | | | | |
| EXAMPLE | DEVELOPER | DEVELOPER | 9 | 114 | 107 | 7 |
| 9 | 9 | W1 | | | | |
| EXAMPLE | DEVELOPER | DEVELOPER | 51 | 114 | 107 | 7 |
| 10 | 10 | W1 | | | | |
| EXAMPLE | DEVELOPER | DEVELOPER | 20 | 120 | 105 | 15 |
| 11 | 11 | W1 | | | | |
| EXAMPLE | DEVELOPER | DEVELOPER | 50 | 113 | 113 | 0 |
| 12 | 12 | W3 | | | | |
| EXAMPLE | DEVELOPER | DEVELOPER | 9 | 114 | 107 | 7 |
| 13 | 13 | W1 | | | | |
| COMPARATIVE | DEVELOPER | NONE | 20 | 114 | — | — |
| EXAMPLE 1 | 12 | | | | | |
| COMPARATIVE | DEVELOPER | NONE | 20 | 122 | — | — |
| EXAMPLE 2 | 13 | | | | | |

| | ADHESION | | | | | |
|---|---|---|---|---|---|---|
| | AMOUNT | | ESCA | | | |
| | [g/m²] | | AREA | | LOW- | |
| | CYAN | WHITE | RATIO | | TEMPERATURE | VARNISH |
| | TONER | TONER | [%] | SEPARABILITY | FIXABILITY | COATABILITY |
| EXAMPLE | 20 | 0 | 8.0 | R2 | R3 | R2 |
| 1 | | | | | | |
| EXAMPLE | 20 | 0 | 4.4 | R3 | R4 | R2 |
| 2 | | | | | | |
| EXAMPLE | 20 | 0 | 9.6 | R2 | R4 | R3 |
| 3 | | | | | | |
| EXAMPLE | 20 | 0 | 6.3 | R3 | R4 | R3 |
| 4 | | | | | | |
| EXAMPLE | 10 | 10 | 8.2 | R4 | R3 | R3 |
| 5 | | | | | | |
| EXAMPLE | 10 | 10 | 6.8 | R2 | R5 | R4 |
| 6 | | | | | | |
| EXAMPLE | 10 | 20 | 7.3 | R4 | R5 | R3 |
| 7 | | | | | | |
| EXAMPLE | 10 | 20 | 5.8 | R4 | R5 | R4 |
| 8 | | | | | | |
| EXAMPLE | 10 | 10 | 7.2 | R3 | R3 | R2 |
| 9 | | | | | | |
| EXAMPLE | 10 | 10 | 5.1 | R2 | R4 | R2 |
| 10 | | | | | | |
| EXAMPLE | 10 | 20 | 8.0 | R3 | R3 | R3 |
| 11 | | | | | | |
| EXAMPLE | 10 | 20 | 6.0 | R4 | R5 | R4 |
| 12 | | | | | | |
| EXAMPLE | 10 | 10 | 7.0 | R3 | R3 | R2 |
| 13 | | | | | | |
| COMPARATIVE | 20 | 0 | 3.6 | R1 | R3 | R1 |
| EXAMPLE 1 | | | | | | |
| COMPARATIVE | 20 | 0 | 10.5 | R4 | R3 | R1 |
| EXAMPLE 2 | | | | | | |

In Table IV, “content of amorphous polyester [% by mass]” refers to the content of amorphous polyester in the toner base particle of the toner in the cyan toner.

As shown in the above results, by using the present disclosure image forming method, compared to the comparative example, even when image formation is performed using an image forming apparatus for continuous media, separability from the fixing device can be ensured. In addition, it can be recognized that it is also capable of high-speed operation due to the use of an image forming apparatus for continuous media that is excellent in varnish coatability and low-temperature fixability and enables high-speed printing.

According to the above embodiment, even when image formation is performed using a continuous printing machine, it is possible to ensure separability from the fixing device without reducing the amount of release agent on the image surface, thereby providing an excellent image forming method in terms of post-processing. Furthermore, by the above means, it is possible to provide an image forming method excellent in high speed and low-temperature fixability in a continuous printing machine.

The mechanism of expression or action of the above effect is not clear, but is inferred as follows.

By setting the area ratio of elements derived from inorganic fine particles to the total area of all elements measured by X-ray photoelectron spectroscopy (ESCA) of the toner image within a range of 4 to 10%, the area ratio of elements derived from inorganic fine particles on the surface of the toner image increases. That is, the external additive is not embedded in the image but is in a state of protruding convexly from the surface of the image. Therefore, due to the convex external additive protruding from the image surface, at the time of fixing, the continuous medium comes into point contact with the external additive. As a result, even when a high-speed continuous printing machine is used, separation can be ensured regardless of the type or amount of release agent.

In addition, if varnish is applied in post-processing, for example, materials such as varnish can get between the external additives. Therefore, the area in contact with the varnish increases, ensuring coating properties and adhesion of the varnish and the like, and providing excellent post-processing properties.

Furthermore, since a toner image is formed on the continuous sheet medium, it is preferable to perform conveyance by a roll-to-roll method and to form a toner image on the conveyed continuous sheet medium using a continuous printing machine. By using a roll-to-roll continuous printing machine, the continuous medium is pulled downward immediately after fixing. Therefore, compared to the case of using a sheet-fed printing machine, the external additive is less likely to be buried in the image, and the amount of external additive protruding from the image surface also increases.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming method for forming a toner image on a continuous medium using a toner, wherein
an area ratio of an element derived from an inorganic fine particle to a total area of all elements measured by X-ray photoelectron spectroscopy (ESCA) of the toner image is within a range of 4 to 10%,
the toner has a toner base particle, and
the toner base particle contains a release agent and an amorphous polyester.

2. The image forming method according to claim 1, wherein
the element derived from the inorganic fine particle is Si or Ti.

3. The image forming method according to claim 1, wherein
the release agent is a hydrocarbon wax.

4. The image forming method according to claim 1, wherein
a content of the amorphous polyester is within a range of 10 to 50% by mass with respect to a content of the toner base particle,
the toner image is printed on a white toner image containing a white pigment, and
a difference in softening point between the toner and a white toner containing the white pigment is 14° C. or less.
